(19) United States
(12) Patent Application Publication
(10) Pub. No.: US 2026/0300614 A1
(43) Pub. Date: Oct. 1, 2026

(54) CROSS-TENANT EVENT PROCESSING BY A RECAPITULATION CONTENT GENERATION SERVICE FOR A CONTENT COLLABORATION PLATFORM

(71) Applicant: Atlassian Pty Ltd., Sydney (AU)

(72) Inventors: Avanti Shivani Prasanna, Los Angeles, CA (US); Nidhi Raj Jayanarasimha, San Jose, CA (US); Vijay Bhaskar Chowdary Kandra, Austin, TX (US)

(21) Appl. No.: 19/093,094

(22) Filed: Mar. 27, 2025

(51) Int. Cl. G06F 40/166; G06F 3/0482; G06F 3/0483

(52) U.S. Cl. CPC G06F 40/166; G06F 3/0482; G06F 3/0483

(57) ABSTRACT

A method for generating editable pages that recapitulate a user’s use of one or more platforms—on a platform-wide basis—is described herein. The method may process data events generated from interactions between users associated with multiple tenants and from multiple platforms of a platform suite. Due to the trillions of data events generated platform-wide, serverless compute services are employed at each step, described herein, to download compiled data and generate the editable recap pages in parallel, resulting in a concurrent roll-out of user-specific editable recaps showcasing each user’s achievement.

### TECHNICAL FIELD

Embodiments presented herein relate to content collaboration platforms, issue tracking platforms, and other work-management platforms. In particular, embodiments described herein relation to systems and methods for generating a user-specific recapitulation of a user’s usage of one or more platforms as an editable content item.

### BACKGROUND

Collaboration and other productivity platforms may be offered as a suite for enterprises to enhance, document, and streamline their work. For example, content collaboration platforms are useful tools for enhancing collaboration and sharing knowledge across a team and across an organization. Issue tracking platforms are useful tools for tracking and documenting issue items across an organization, practice groups, or groups of enterprises. Often, the volume of data from daily interaction of the millions of users in the platform makes it difficult to capture the amount of work users produce short term and long term.

### SUMMARY

Embodiments described herein include a method for generating a plurality of editable pages in a content collaboration platform, the plurality of editable pages may include a respective recap of a respective user’s usage of at least two platforms for a predetermined period of time. In some cases, the method may include sending a request to compile a data table based on data events from the at least two platforms. This request may have the predetermined period of time for the data events and a list of data event types to be aggregated to compute a corresponding plurality of aggregated values for each user of a plurality of users. In response to the request, the method may aggregate a corresponding plurality of values for each user of the plurality of users based on a number of data events, each aggregated value from the plurality of values may correspond to a respective data event type, the plurality of users may include a first plurality of users from a first tenant and a second plurality of users from a second tenant, the corresponding plurality of aggregated values for each user of the plurality of users may be stored in the data table. Subsequent to generating the data table, the data table may be chunked into a plurality of data chunks, each data chunk of the plurality of data chunks may include data from at least two tenants. In some cases, the plurality of data chunks may be downloaded, each data chunk downloaded by a respective serverless compute service. From the plurality of data chunks, a respective recap editable page may be constructed and may include a corresponding plurality of editable objects generated based on the corresponding plurality of aggregated values associated with each respective user of the plurality of users. In response to a user input from a particular user, display of a particular recap editable page may be caused in a graphical user interface of the content collaboration platform, the graphical user interface may include a navigation panel including an array of tree elements arranged hierarchically, each tree element of the array of tree elements selectable to cause display of a respective page, and a content region configured to display the particular recap editable page.. The particular editable page may include the corresponding plurality of editable objects associated with the particular user, and a selectable graphical element corresponding to a first page created by the particular user, the selectable graphical element configured to cause navigation to the first page, the first page associated with a plurality of first page data events generated from a plurality of interactions of the particular user with the first page.

In some embodiments, each data chunk may include a respective chunk index, and the respective serverless compute service may be a respective first lambda of a plurality of first lambdas. The method may also include: in response to downloading a particular data chunk from the plurality of data chunks, generating a particular event in a chunk download queue; and subsequent to obtaining the particular data chunk download event from the chunk download queue, executing a respective second lambda of a plurality of second lambdas, each respective second lambda configured to construct a respective recap editable page.

In some cases, each corresponding plurality of aggregated values may include: a first aggregated value corresponding to number of pages created by each respective user of the plurality of users within the predetermined period; a second aggregated value corresponding to a number of comments created by each respective user of the plurality of users within the predetermined period; and a third aggregated value corresponding to a number of pages viewed by each respective user of the plurality of users within the predetermined period.

In some examples, subsequent to constructing the particular recap editable page corresponding to the particular user, a notification may be generation. The notification may include: a summary narrative based on the particular recap page, the summary narrative comprising at least two preview objects generated from at least two editable objects from the corresponding plurality of editable objects; and a link selectable to cause navigation to the particular editable page. In some examples, the notification may be caused to display in a window overlayed over a user interface of an issue tracking platform associated with the particular user.

In some embodiments, for each user of the plurality of users: a respective plurality of pages associated with interactions between the particular user and the content collaboration platform may be identified; a page interaction value for each page of the plurality of pages based on a number of interactions may be calculated; the first page from the plurality of pages based on the respective calculated interaction value may be selected, and the selectable graphical element associated with the first page may be generated. In some cases, the plurality of users is selected from a global number of users of the at least two platforms satisfying a recap generation criteria.

Some examples described herein include a method for aggregating platform event data on a platform-wide basis for a plurality of users and generating user-specific recap pages within a content collaboration platform. The method may include, for each user of the plurality of users: receiving a plurality of data events generated from the content collaboration platform, the plurality of data events occurring over a predefined period of time, the plurality of data events associated with each user, each data event of the plurality of data events having a respective data event type from a plurality of data event types; for a first data event type of the plurality of data event types, compute a respective first value by aggregating data events from the plurality of data events having the first data event type; and for a second data event type of the plurality of data event types, compute a respective second value by aggregating data events from the plurality of data events having the second data event type, the first data event type different from the second data event type. An aggregated data table may be generated that includes a user ID for each user of the plurality of users; and the respective first and second value for each user of the plurality of users. The aggregated data table may be partitioned into a plurality of data chunks, the partitioning may be based on a file size of the data table and a number of the plurality of users, each data chunk comprising a respective subset of users and including data from a plurality of tenants. Each respective data chunk of the plurality of data chunks may be downloaded via a respective first serverless compute service of a plurality of first serverless compute services. For a particular data chunk, a plurality of editable pages within the content collaboration platform may be generated, each editable page of the plurality of editable pages may correspond to a respective user of the subset of users from the plurality of users, each editable page of the plurality of editable pages may have the respective first value and second value for each user of the subset of users. In response to generating a particular editable page from the plurality of editable pages, a notification to a particular user associated with the particular editable page may be generated. The notification may include a summary of the content of the editable page, the content generated based on at least a portion of row data from the aggregated data table corresponding to the particular user, and a link configured to redirect the particular user to the particular editable page within the content collaboration platform. Subsequent to a user selection of the link and in response to the particular user satisfying an authentication criteria, display of the particular editable page within a user interface of the content collaboration platform may be caused. The user interface of the content collaboration platform may include a navigation panel including an array of tree elements arranged hierarchically, each tree element of the array of tree elements selectable to cause display of a respective page; and a content region configured to display the particular editable page including a first editable object based on the first value, and a second editable object based on the second value. In response to a user input, the particular editable page may be published, the published particular editable page may be viewable to other users of the content collaboration platform satisfying a permissions scheme.

In some cases, the plurality of data chunks include at least 1000 data chunks, the generating the plurality of editable pages within the content collaboration platform for the particular data chunk includes executing a plurality of second serverless compute services, each second serverless compute services of the plurality of second serverless compute services configured to generate a respective editable page in parallel, and the method further includes generating a respective plurality of editable pages for each data chunk of the at least 1000 data chunks.

In some cases, the method includes: computing a respective third value for each page of a plurality of pages associated with the particular user, the computing including aggregating a number of data events from the plurality of data events having a third data event type, the third data event type different from the first and second data event types; selecting a user-edited page from the plurality of pages based on a particular third value corresponding to the user-edited page; and obtaining a particular page ID corresponding to the user-edited page; retrieving page content associated with the page ID; generating a selectable graphical element including a portion of the page content, the selectable graphical element operable to cause navigation to the user-edited page; and causing display of the particular third value displayed adjacent to the selectable graphical element within the particular editable page.

In some embodiments, prior to causing display of the particular editable page, display of a preview page may be caused. The preview page may include: at least a portion of the particular editable page, including the first value and the second value; a first user control configured to cause display of the particular editable page in the content region of the content collaboration platform; and a second user control configured to cause the particular editable page to publish. In some examples, the first event type is a page edit data event and the second event type is a page view data event. In some cases, the first event type is one of a page creation data event, a whiteboard creation data event, a database creation data event, a blog creation data event, or a selectable graphical element creation data event. In some embodiments, subsequent to generating the notification, a window overlayed over the content region may be displayed, the window including the notification, the notification operable to cause navigation to the particular editable page in response to a user selection.

Some embodiments described herein include a method for generating a respective recap page for each eligible user on a platform-wide basis, each respective recap page configured to narrate a corresponding eligible user’s use of a content collaboration platform during a predetermined period of time, the platform-wide basis including a plurality of tenants. The method may includes: For each eligible user of a platform-wide user base, the platform-wide user base including a plurality of tenants of the content collaboration platform: computing, from a plurality of data events associated with each eligible user, a respective first aggregated value based on a number of pages created by each eligible user during a predetermined period of time and a respective second aggregated value based on data events associated with a respective user-edited page; generating a platform-wide recap table having a user ID corresponding to each eligible user, the respective first aggregated value computed for each eligible user, the respective second aggregated value computed for each eligible user, and a respective page ID associated with each respective user-edited page; in response to receiving a message from a message queue comprising a data chunk index corresponding to a data chunk from the recap table, downloading the data chunk of the recap table, the data chunk having data from a subset of eligible users from the platform-wide user base, the subset of users including users associated with at least two tenants from the plurality of tenants. From the data in the downloaded data chunk: a plurality of recap pages corresponding to the subset of eligible users within the content collaboration platform may be generated. The plurality of recap pages may have a first editable object generated based on the respective first aggregated value, a second editable object generated based on the respective second aggregated value, and a respective graphical element associated with each respective user-edited page. Subsequent to authenticating a particular user in accordance to an authentication criteria, a particular recap page within a user interface of the content collaboration platform may be displayed. The user interface of the content collaboration platform may include a navigation panel including an array of tree elements arranged hierarchically, each tree element of the array of tree elements selectable to cause display of a respective page, and a content region configured to display the particular recap page as an editable page, the particular recap page comprising a graphical user element selectable to cause navigation to a particular user-edited page.

In some cases, subsequent to generating the particular recap page and in response to a user input, the particular recap page may be published, the publishing may add view access to a subplurality of users different from the particular user. In some examples, the graphical user element has at least a portion of content from the particular user-edited page. In some embodiments, the plurality of data events is a first plurality of data events. The method may also include, for a second plurality of data events generated from an issue tracking platform, and associated with each eligible user: computing, a respective third aggregated value based on a number of issue items associated with each eligible user in a predetermined period of time; and generating the platform-wide recap table further comprising each respective third aggregated value.

In some examples, each recap page includes a first section including the respective first aggregated value and the respective third aggregated value, a second section including the respective graphical element associated with the content collaboration platform, and a third section including the respective third aggregated value associated with the issue tracking platform. In some embodiments, the respective selectable graphical element is a first respective selectable graphical element, and the third section further includes a respective second graphical element selectable to cause display of an issue item in an issue tracking platform.

### BRIEF DESCRIPTION OF THE DRAWINGS

Reference will now be made to representative embodiments illustrated in the accompanying figures. It should be understood that the following descriptions are not intended to limit this disclosure to one included embodiment. To the contrary, the disclosure provided herein is intended to cover alternatives, modifications, and equivalents as may be included within the spirit and scope of the described embodiments, and as defined by the appended claims.

FIG. 1 depicts a simplified diagram of a system, such as described herein, configured to generate an editable recap page in a content collaboration platform.

FIG. 2 depicts a simplified functional system diagram of a system that can be used to generate an editable recap page in a content collaboration platform.

FIGS. 3A–3E depict example user interfaces of a content collaboration platform that includes an editable recap page and/or page preview.

FIGS. 4A–4B depict an example notification in response to the editable recap page being generated.

FIG. 5 depicts a simplified functional system diagram of a system that can be used to generate a multi-platform recap item.

FIG. 6 depicts an example user interface of a content collaboration platform that includes a multi-platform editable recap page.

FIG. 7 depicts an example user interface of an issue tracking platform that includes an editable recap issue item.

FIG. 8 depicts a method for generating an editable recap page.

FIG. 9 depicts a sample electrical block diagram of an electronic device that may perform the operations described herein.

The use of the same or similar reference numerals in different figures indicates similar, related, or identical items.

Additionally, it should be understood that the proportions and dimensions (either relative or absolute) of the various features and elements (and collections and groupings thereof) and the boundaries, separations, and positional relationships presented therebetween, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

### DETAILED DESCRIPTION

Embodiments described herein relate to systems and methods for automatically generating a user-specific recapitulation (hereinafter “recap”) showcasing each user’s use of the platform(s) during a predetermined period of time. In some embodiments, the recap is generated as an editable page in a content collaboration platform. The editable page of the recap may be generated on a platform-wide basis (e.g., millions of users) contemporaneously.

Many enterprises collect data events to detect significant changes within a system, to gain insight on users’ needs, to develop strategies for improvement, to ensure appropriate quality control, and so on. Collecting data events—including user clicks, page views, tickets, file modifications, logins, and the like—results in very large amount of data. This data is generally stored in data lakes or other databases. Because of this large amount of data, the corresponding computing time needed to leverage the data increases exponentially over time. In turn, as the computing time increases, systems may overload and operations to utilize the data become unsustainable. Consequentially, available data is often underutilized.

This issue is compounded in collaborative platforms and other productivity platforms, such as issue tracking platforms, project management platforms, video messaging and editing platforms, and the like. For example, content collaboration platforms often include millions of users from a wide range of enterprises. Each user is typically involved in extensive editing, revising, publishing, and commenting on a diverse range of pages and spaces. Likewise, many users of the content collaboration platform also have access to other productivity platforms that also produce a large amount of data events per user. Each of these data events are linked to each user and each enterprise, and across the different platforms.

In many cases, obtaining these data events can aid users track their productivity, self-advocate during performance reviews, provide insight into possible areas for improvement, and the like. However, given the millions of users per platform, compiling, aggregating, and transforming this data may be unsustainable. More specifically, generating a platform-wide recap may require enormous amounts of data gathered across enterprises and/or across tenants. All this data from different tenants may be required to be retrieved and processed synchronously such that the same time period of data events is used for all eligible users and such that the recaps are rolled out concurrently for all eligible users. Similarly, an even larger amount of data is involved in a cross-tenant and cross-platform-wide recap.

The methods and systems described herein includes a scalable, fast, and cost-effective way of generating and displaying a platform-wide recap (e.g., presented as an editable page, as an editable issue item, or the like) for each eligible user a platform. Generally, the number of eligible users may be in the millions, tens of millions, billions, and the like. In some embodiments, the method leverages a multitude of serverless compute services, such as lambdas, to download and process data chunks in multiple stages. Each of the multitude of serverless compute services may operate in parallel. In some cases, a data lake may store data events from a user of a content collaboration platform over the lifetime of the user’s use of the platform. In response to a request for select data events of all eligible users over a predefined period of time (e.g., 6 months, 1 year, and the like), an analytics and data processing engine may aggregate and compile the requested data in data chunks. The compiled and aggregated data may form part of a table. Each data chunk may correspond to thousands of entries (e.g., rows) from the table. Thus, for the total number of eligible users, thousands of data chunks having thousands of rows may be generated.

In some cases, the data events compiled and/or aggregated may include a data event type, such as page create, page view, page edit, scroll, log in, and the like. The aggregated values calculated may be based on the data event type. For example, for a first data event type, a first value may be calculated using a plurality of data events that have the first data event type. Similarly, a second value may be calculated from a different plurality of data events that have the second data event type. A row of the aggregated data table compiled by the engine may include a user ID associated with the user, and the first and second values. Each row from the millions of rows in the aggregated table may include respective a respective userID, and respective first and second values associated with each user. Depending on the request, the aggregated table may include a multitude of values, page IDs, and other aggregated data. In some embodiments, the aggregated data table is downloaded in chunks, according to a chunk index. In this example, the first value and the second value associated with a user ID may remain in the same partition or chunk along with all the data associated with a particular user (e.g., corresponding to the user ID).

Once the aggregated data table is compiled, a plurality serverless compute services may download the data. For instance, each serverless compute service may download a respective chunk of the aggregated data table in parallel with respect to other serverless compute services. For this step, for example, hundreds or thousands of serverless compute services may be instantiated contemporaneously to download the data table.

From each chunk, thousands of respective editable pages may be generated for respective users whose aggregated data events are included in that chunk. For example, for each chunk out of the thousands of chunks, parallel serverless compute services may be employed to generate a recap page corresponding to each user. The editable page for each user may be generated within a content collaboration platform and include the first value and the second value, each the first and second values representing a recap of the user’s work within the content collaboration platform over the established period of time. In some examples, the generated recap editable page includes selectable graphical elements that correspond to pages with which the user has interacted, created, commented, or the like. The selectable graphical elements are configured to cause navigation to a page associated with the graphical element. In some cases, the selectable graphical element includes metadata from the page and/or a preview of the page content.

Upon generating the page, a notification may be sent to the user that includes a summary of the recap and a link to the editable page. The user may access the content collaboration platform (e.g., may satisfy an authentication criteria) to view, edit, and/or publish the editable recap page. Generally, the content collaboration platform may include a user interface having a navigation panel and a content region. The navigation panel may show an array of tree elements arranged hierarchically. The tree elements may be selectable to display a respective page in the content panel. The content panel displays content of the user-generated pages, including text, images, videos, graphical user elements, comments, and the like.

In some examples, a preview of the recap editable page is presented as a window overlaying the navigation panel and the content panel. The preview window may include a portion of the editable page or the entire editable page content. The preview window may also include user controls configured to publish the page and to edit the page. In some cases, prior to publishing, the editable recap page is only viewable and/or editable by the user for which the recap page is generated. Upon publishing, the recap page becomes viewable to other users and/or to select users. In some cases, other users may be restricted from writing access. The edit user control may cause the preview window to close and the editable recap page to be displayed within the content panel of the content collaboration platform.

Through the use of parallel serverless compute services, such as lambdas, the above method enables generating a platform-wide recap in a sustainable yet timely period of time.

In some cases, a combined recap item (e.g., a recap editable page, a recap editable issue) may be generated for millions of users which cross-utilize multiple platforms. The combined recap item may include a summary of a user’s usage of several platforms, such as the content collaboration platform, issue tracking platform, video messaging platform, developer platforms, and the like. For example, the combined recap item may include a section having aggregated values corresponding to content collaboration platform data events (e.g., pages created, pages viewed, blackboards created, blogs created, and the like). In addition, the combined recap item may include a different section having aggregated values corresponding to issue tracking platform data events (e.g., issues created, issues closed, issues edited, and the like). The recap item may be created on one or more of the platforms. For example, the recap item may be generated as an issue item within the issue tracking platform.

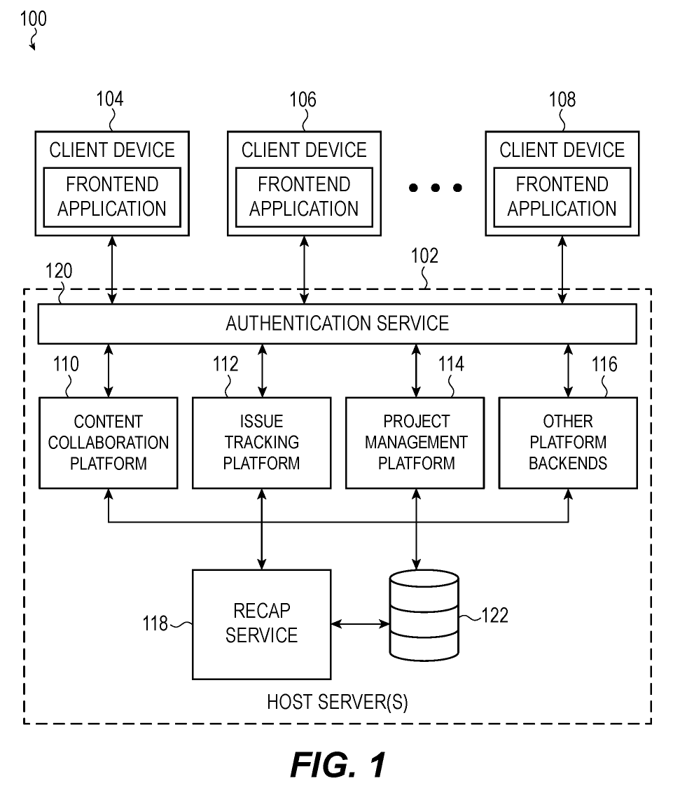

These foregoing and other embodiments are discussed below with reference to FIGS. 1–9. However, those skilled in the art will readily appreciate that the detailed description given herein with respect to these figures is for explanation only and should not be construed as limiting.

FIG. 1 depicts a simplified diagram of a system 100 that is configured to generate an editable recap page that includes aggregated values based on data events associated with a user for a predetermined period of time. The system 100 is depicted as a client-server architecture but it may be appreciated that other communications architectures are possible.

The system 100 includes a set of host servers 102 which may be one or more virtual or physical computing resources (collectively referred in many cases as a “cloud platform”). In some cases, the set of host servers 102 can be physically co-located or may be positioned in a geographically-unique location.

The set of host servers 102 can be communicatively coupled to one or more client devices, such as client device 104, client device 106, and client device 108. The client device 104 can be implemented as any suitable electronic device. In many embodiments, client device 104, client device 106, and client device 108 may be a personal computing device, such as a desktop computer, laptop computer, mobile phone, or tablet.

The set of host servers 102 can be supporting infrastructure for one or more backend applications, each of which may be associated with a particular software platform, such as a content collaboration platform 110, an issue tracking platform 112, a project management platform 114, and the like. Other platforms 116 may include ITSM systems, chat platforms, messaging platforms, blackboards, video platforms, developer platforms, and the like. These backends can be communicatively coupled to a recap service 118 that can be leveraged to aggregate and provide a user-specific recap based on data events from the one or more platforms.

Each of the content collaboration platform 110, the issue tracking platform 112, the project management platform 114, and the other platforms 116 may be instantiated over physical resources provided by the set of host servers 102. Once instantiated, respective frontends for each of the platforms are rendered.

More specifically, the content collaboration platform 110 backend can be configured to communicably couple to a content collaboration platform frontend instantiated by cooperation of a memory and a processor of the client device 104, client device 106, or client device 108. Once instantiated, the content collaboration platform frontend can be configured to leverage a display of the client device, such as client device 104, to render a graphical user interface so as to present information to a user of the client device 104 and so as to collect information from a user of the client device 104.

Each the content collaboration platform 110, the issue tracking platform 112, the project management platform 114, and the other platform backends 116 can be configured to communicatively couple to an authentication service 120. In some embodiments, the client devices, such as client device 104, client device 106, and/or client device 108, may be configured to send an authentication token with each request transmitted to each respective platform to access content. In some cases, each request/response transmitted as described above or elsewhere herein may be accompanied by user authentication tokens, user session tokens, API tokens, or other authentication or authorization credentials. In response to the user associated with a client device, such as client device 104, satisfying an authentication criteria, access is granted to one or more of the platforms based on the user’s credentials.

The content collaboration platform 110, the issue tracking platform 112, the project management platform 114, and the other platform backends 116 may be configured to receive and store data events of a user’s actions at a client device interacting with one or more of the platforms and/or host service(s) 102. For example, client device 104 may be executing an instance of a content collaboration platform 110 frontend via a web browser. In this example, the content collaboration platform 110 may capture clicks away from a page, scrolling, editing, and the like. In some cases, data events may include a file upload, a page update, a server error, a trigger event, system logs, API calls, application launches, video plays, dwell time for a page or document, using interactions including likes, comments, and the like. Once captured, the data events may be uploaded in one or more databases, or other data repositories. In many embodiments, the data events are stored in a data lake 122.

The data events captured via a user interaction with any of the platforms may be accessed via the recap service 118. In particular, the recap service 118 may include cloud-based platforms, microservices, lambdas, and other services configured to aggregate, download, and generate a recap for the user, such as an editable page in a content collaboration platform 110.

In some cases, the recap service 118 may aggregate the data events accessed from data lake 122 and organize the aggregated data into a predefined format or according to a schema. For example, the aggregated data may represent a number of created pages, a number of edited pages, a number of spaces visited, and the like, as cells in the table. In turn, each value may be stored in a single row for each eligible user of a content collaboration platform, where the number of rows may correlate to the number of users. In some examples, the data events are extracted for a predefined period of time. For example, the aggregated data may be for a period of a year, six months, one month, lifetime use, and the like.

Once the data is aggregated, the recap service 118 may partition the aggregated data into data chunks for downloading. This partition may be based on predetermined file size, available computing resources, a predetermined number of files, a completion time requirement, and the like. The partitioned aggregated data is then downloaded and a recap page may be generated for each eligible user. While the above examples focus on an editable page, it should be noted that an editable recap item, such as an issue, may be generated depending on the destination platform. In some cases, the recap service 118 may be configured to generate notifications that a recap page is ready to view and/or edit.

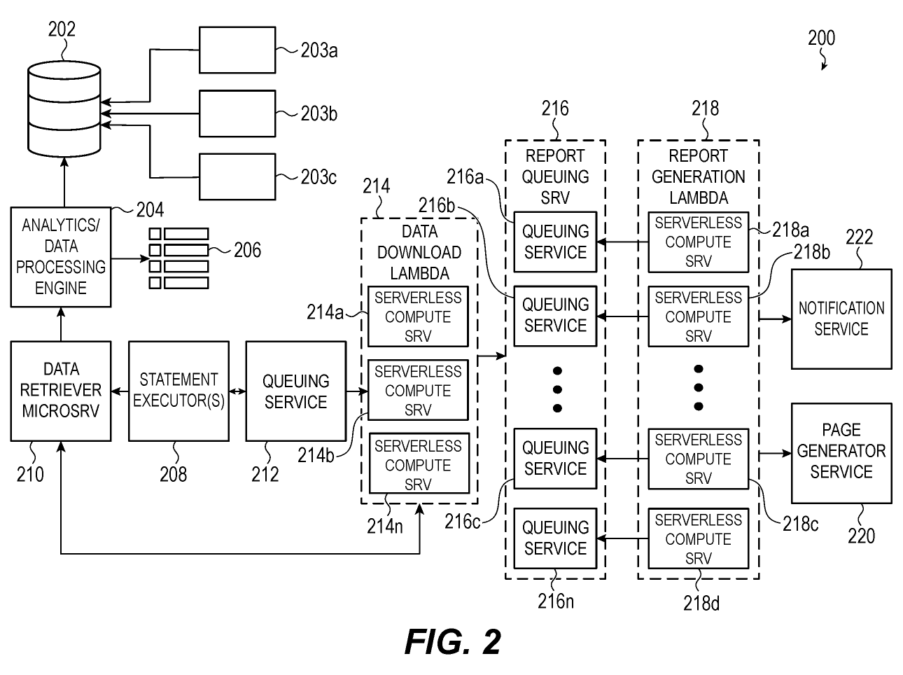

FIG. 2 shows a simplified diagram of a system 200 configured to generate editable recap pages for a plurality of users—platform-wide—in a content collaboration platform. The recap may be generated by aggregating data events generated by an interaction between each user and the platform. As used herein, the term “platform-wide” may refer to significantly all users of the content collaboration platform for which a recap can be generated. Specifically, “platform-wide” users refers to a cross-tenant and cross-enterprise global user base (generally, in the order of millions or tens of millions). In some cases, from a global number of users, a plurality of users are selected to generate the editable recap page. The selection may be based on a recap generation criteria, which may include users associated with at least two platforms, users whose account was opened before the start of the predetermined period, and the like. Generally, the recap generation criteria may encompass a substantial majority of platform(s) users.

As explained above, data events, such as “page view,” “page created,” “user commented on this page,” are stored in a data lake 202. In some cases, the data may be stored in a single event track table in the data lake 202 for all users of the content collaboration platform, including from multiple tenants, such as tenant 203a, 203b, and 203c. In some cases, the multiple tenants may be associated with multiple enterprises, though other data management structures are envisioned. For example, the event track table may include data from multiple tenants and/or data from all the tenants associated with the content collaboration platform. In this example, data for each user of a plurality of users (e.g., a platform-wide user base) may be stored in a respective row. In other examples, the event track table may be multiple tables, organized according to a particular enterprise, according to a particular tenant, geographical region, according to other data governance requirements, or the like. For context, the event track table may include records in the order of billions, trillions, or greater, depending on the number of users for the content collaboration platform.

The data lake 202 is communicably coupled to an analytics and data processing engine 204. In response to a request to compile a data table for a platform recap, the analytics and data processing engine 204 is configured to access the event track table stored in the data lake 202, read the data from the event track table, and perform computational tasks on the data—such as aggregating multiple data events according to types of events, and compile an aggregated table. The analytics and data processing engine 204 outputs the compiled aggregated table, such as table 206. As described herein, the term aggregated table refers to the table generated by the analytics and data processing engine 204 which includes computed metrics representing an aggregation of data events (e.g., according to data type), as well as user unique IDs, page IDs, and other data requested in a predefined table for generating the user recap report.

In some examples, due to the large amount of data, the analytics and data processing engine 204 may be a distributed computing environment capable of executing a set of tasks in parallel. In some cases, the engine 204 may divide a job in stages, where each stage includes a plurality of tasks that are executed in parallel. The analytics and data processing engine 204 may include a cluster manager configured to allocate resources to execute the job. In some cases, the aggregation and other computational tasks (e.g., map, reduce, join) may be performed using one or more Application Programming Interfaces (API). The analytics and data processing engine 204 is configured to store the aggregated table 206 in a temporary store (e.g., as a temporary table).

As one example, the analytics and data processing engine 204 may receive a plurality of data events generated from the content collaboration platform for each user of a plurality of users. Generally, the plurality of data events may be data events occurring over a predefined period of time. In some cases, the plurality of data events for each user include a respective data event type from a plurality of data event types. To generate a recap, aggregated values may be computed to gain insights on the amount of work a user has done in the predefined period. For instance, for a first data event type of the plurality of data event types, a respective first value (e.g., a first value for each user) may be computed by aggregating data events from the plurality of data events having the first data event type. Similarly, a second value for each user based on a second data event type of the plurality of data event types may be computed by aggreging data from the second data event type. For example, a first event type may be “pages viewed” and thus the first aggregated value is configured to show how many pages the user has read and/or gained insight on in the predetermined period of time. As another example, the first event type may be one of a page creation data event, a whiteboard creating data event, a database creation data event, a blog creation data event, or a selectable graphical element creation data event. In addition to aggregated values, the aggregated table may include page IDs selected based on a criteria (e.g., most viewed page, most commented page), @mentions and other data events that also relate to other users, other platforms, other data objects, or other events.

The aggregated table 206 may include a respective user ID for each user of the plurality of users, a plurality of aggregated data events (e.g., a respective first and second value, as discussed above), and other page IDs. Once the analytics and processing engine 204 completes assembling the aggregated table 206, the aggregated table 206 is associated with a unique job ID, which enables a statement executor 208 to query the engine 204. In many examples, the aggregated table 206 includes data from most or all of the users of the platform. In some cases, each row of the aggregated table 206 includes data for a single user and the number of rows represents the number of users in the platform. It may be appreciated that other table configurations are envisioned. For example, in some cases the aggregated table may be generated for select users (e.g., users associated with a particular enterprise, users whose account is older than a predetermined period, and so on).

Due to the size of aggregated table—in the order of millions, tens of millions, or billions—the statement executor 208 may be executed to query whether a job (for example, the aggregated table) is complete. The statement executor 208 executes a periodic query until a confirmation is received that the job is complete. More specifically, the statement executor 208 is communicably coupled to a data retriever microservice 210 which, in turn, is communicatively coupled to the analytics and data processing engine 204. To check the completion status of a job, the statement executor 208 communicates with the data retriever microservice 210 in order to access the job status. The data retriever microservice 210 is configured to check authentication, and, upon a successful authentication, retrieve data in from the analytics and data processing engine 204 including job status. The statement executor 208 queries the job status using a job ID as input to the data retriever microservice 210. In some cases, the statement executor 208 is a lambda. In some cases, the statement executor 208 continues the query until it receives a message that the job, e.g., preparing the aggregated table 206, was successful.

In some examples, the aggregated table 206 may be partitioned or chunked by the analytics and data processing engine 204 into a plurality data chunks. The number of data chunks may be based on a file size of each data chunk and/or a number of users of the plurality of users whose data is included in a given data chunk. Given the number of total users platform-wide, the number of data chunks may be in the order of 500, in the order of 1000, in the order of 1500, in the order of 2000, or in the order of 5000. The number of data chunks multiplied by the average number of users per data chunk approximates the number of platform-wide users. Once the query executes successfully, chunk indices are also generated to identify each data chunk of the plurality of data chunks. In some examples, each of these data chunks includes data for a subset of users of the platform (e.g., of the content collaboration platform) and/or the multiple platform environments, the subset of users may include a first plurality of users associated with a first tenant and having a first plurality of user IDs, and a second plurality of users associated with a second tenant having a second plurality of user IDs.

As each data chunk is available, a queuing service 212 queues each chunk index as a separate event. The queuing service 212 may be a message queuing service deployed in a cloud computing environment. The queuing service 212 may be configured to send and receive messages asynchronously. In some embodiments, the queuing service 212 may support a standard queue, a FIFO queue, or the like.

Once the data chunks are ready to download, a data download lambda 214 is invoked to download each data chunks. The data download lambda 214 may include a first serverless compute service 214a, a second serverless compute service 214b, an nth computing service 214n, or any adequate number of lambdas, depending on the number of data chunks to be downloaded. Each of the serverless compute services 214a–n may be executed in parallel to download each respective data chunk of the plurality of data chunks concurrently or significantly concurrently. The data download lambda 214—through each of its serverless compute services 214a-n—is configured to communicate with the data retriever microservice 210 and provide a respective chunk index in order to retrieve a respective data chunk from a plurality of data chunks. In some cases, each serverless compute service 214a–n may be configured to operate asynchronously to download the data chunks.

As each data chunk is downloaded by a respective serverless compute service 214a–n, a respective download event message is pushed to a report queuing service 216. The report queuing service 216 may include a first queuing service 216a, a second queuing service 216b, a third queuing service 216c, an nth queuing service 216n, and so on. Once a data chunk (e.g., a particular data chunk from the plurality of data chunks) is downloaded, a report generation lambda 218, via a respective serverless compute service 218a–n, pulls the download event message for the data chunk.

As an example, the particular data chunk (which includes data for a subset of users from multiple tenants, enterprises, and/or entities) may be used to generate a plurality of pages within the content collaboration platform. For example, from the particular data chunk, a respective editable page is generated for each user of the subset of users. The generated respective editable page may include or be based on the aggregated values, such as the first and second values computed. To generate each editable page, the report generation lambda 218 executes a respective serverless compute service 218a–n for each row of the data chunk. The editable page is generated by constructing recap objects (e.g., JSON objects) from the chunk data. The recap objects are constructed by converting each row into key-value pairs such that the aggregated table is converted to a machine-readable format for use in an API exchange. For example, to construct graphical user elements, a respective page ID from each row (and thus, from each user) is retrieved. Then, page data, such as a URL, a title, and/or other metadata corresponding to the page ID, is obtained in order to subsequently construct the graphical elements and/or other editable objects within the page.

Once the recap objects are constructed, the constructed recap objects for each user are distributed to the report queuing service 216. As described herein, the report generation lambda may include a first serverless compute service 218a, a second serverless compute service 218b, a third serverless compute service 218c, up to an nth serverless compute service 218n, and therefore each data chunk may be processed in parallel and/or asynchronously.

Based on the constructed recap objects, a page generation service 220 creates a page for the subset of users. For example, the recap objects are converted to an appropriate document format readable by the content collaboration platform. The resulting document format readable by the content collaboration platform may be structured rich text or encoded rich text content in which editor-specific or platform-specific objects or elements are generated. In some implementations, the content may be formatted as a structured data representation which may be formatted using JSON, XML, or other schema or a custom syntax. The structured rich text may be adapted for programmatic manipulation provided by a particular editor or rendering engine. For example the rich content may include @mention objects, selectable graphical elements, embedded content, special characters, content regions, content panels, and other similar elements. The resulting document may include text, image, video, audio, and other formats and classes of user content.

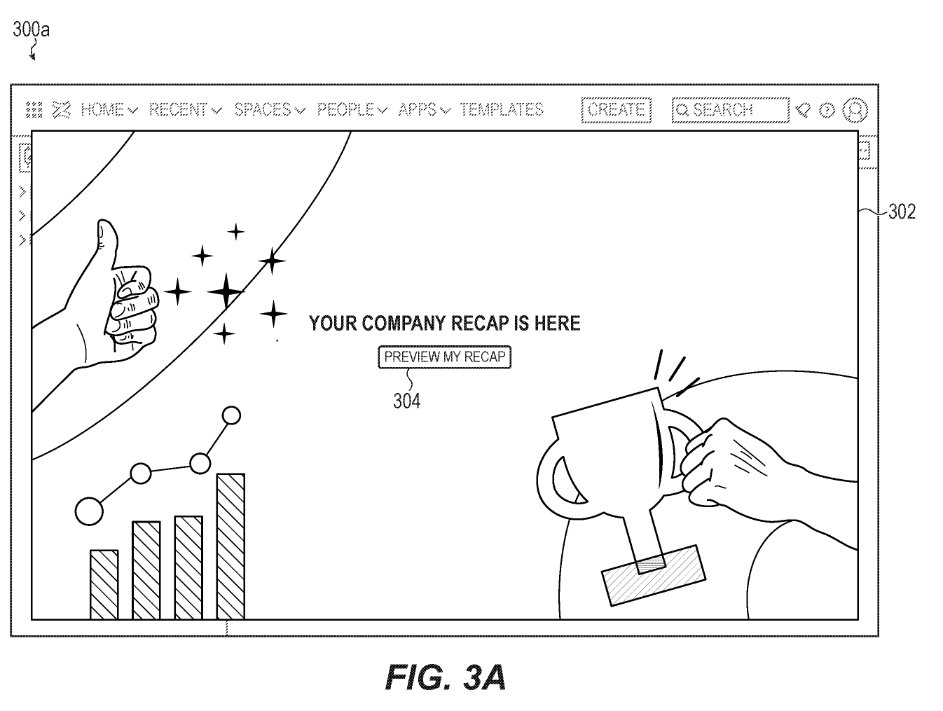

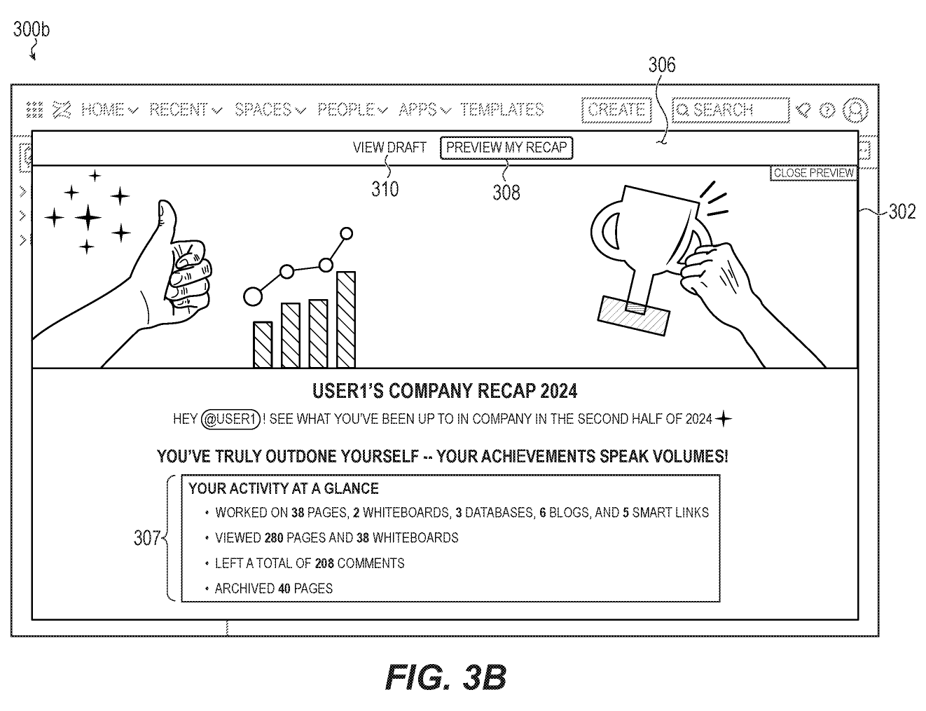

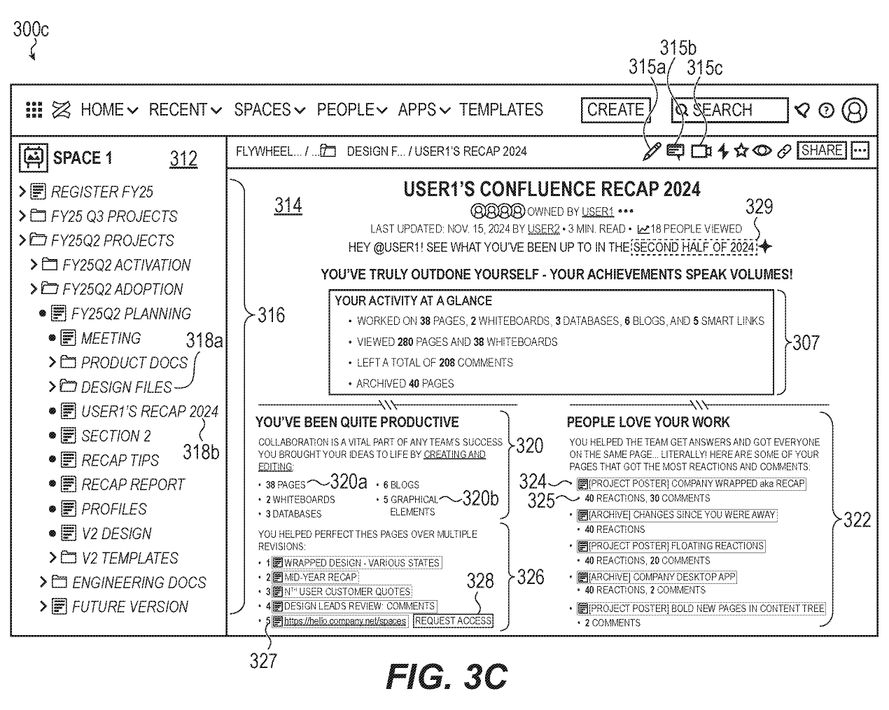

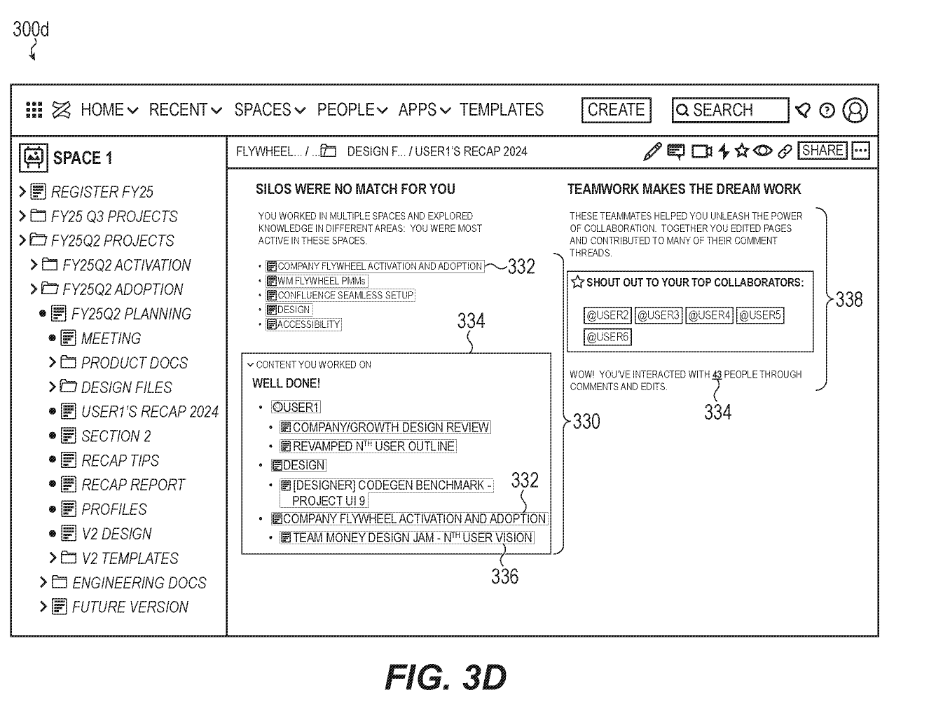

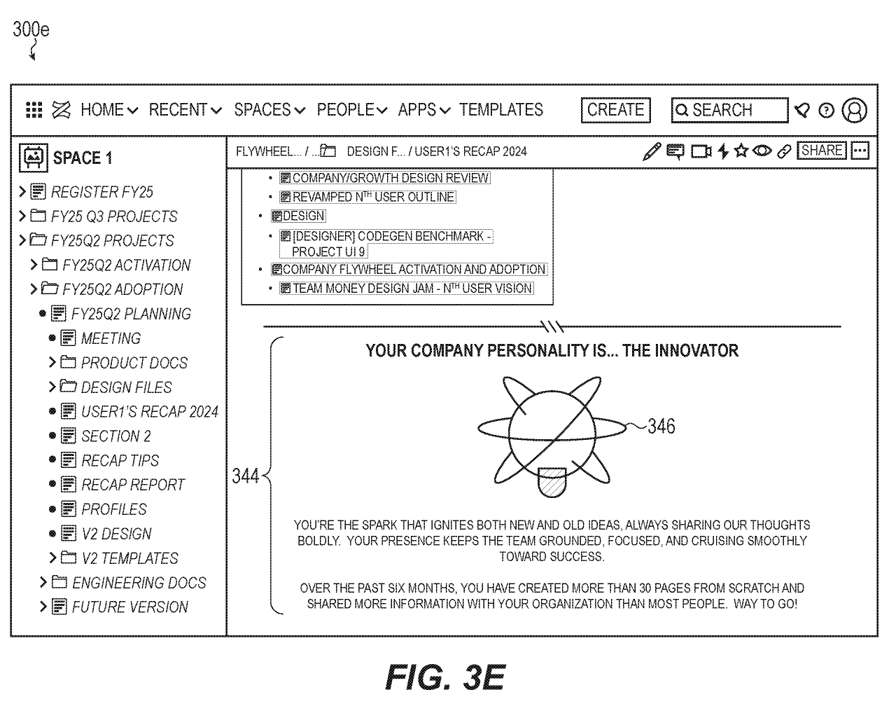

In some cases the subset of users may refer to a subset of users satisfying a report generation criteria. The report generation criteria may identify a plurality of eligible users for which a recap page may be generated. For example, out of millions of users, each data chunk may include information for one thousand users. Out of the thousand users, 900 (e.g., a subset of users) may be active users and therefore meet a report generation criteria. In some cases, the report generation criteria may be based on employment status, minimum usage, subscription level, minimum age of the user account on the platform, user settings consenting to the report, geographical area, and the like. The generated page may be saved to a user’s personal space or other predetermined location. Details on the generated page are provided in the discussion of FIGS. 3C–3E below, a general overview is provided herein for convenience.

Generally, the generated page may include a narrative that describes or recaps each user’s activity and/or work products. The recap page may be editable to the user and include a plurality of editable objects generated using the aggregated data (e.g., generated from the recap objects which, in turn, are based on the aggregated data) and/or which include aggregated values computed to aid in the narrative. For example, the recap page may include a plurality of aggregated values embedded within a graphical user element that portrays to the user the number of times a page created by the user was commented on. As another example, the generated page may include total number of pages edited, total number of pages created, top collaborators, total mentions in a comment, total number of comments, or the like. In some examples, the data events may include total number of clicks in to pages in the platform, distance scrolled, most viewed pages, least viewed pages, total number of words written, total number of graphical elements generated, and the like. In some embodiments, as explained above, the data events are aggregated for a predetermined period of time. The generated page may additionally include selectable graphical elements that link to particular pages associated with the user, selectable graphical elements that link to spaces, and/or other selectable graphical elements that link to other data in a different platform, such as an issue tracking platform. As a non-limiting example, the aggregated table may include, for each user, a respective third value for each page of a plurality of pages. The respective third value may be calculated by aggregating a number of data events form the plurality of data events that have a third event type. From this third value, a user-edited page is selected from the plurality of pages for which a third value was computed. The service may obtain a page ID corresponding to the selected user-edited page and page content is subsequently obtained. A selectable graphical element is generated from the data obtained from the user-edited page and included in the particular recap editable page.

In some cases, the recap narrative may highlight “top” pages for the user. In some cases, the “top” pages may be selected based on a number of interactions with the user, based on a popularity index of the page, and the like. For example, for each user, a plurality of pages may be identified based on data events that indicate a particular user interaction with each page of the plurality of pages. A page interaction value, based in part on an aggregated number of interactions for each page, may be calculated. Based on the calculated page interaction value, a first page from the plurality of pages may be selected. Then, a graphical element is generated for the first page. In some cases, this first page may be displayed as a “top” page or a “featured” page.

The generated page may be generated using a predetermined format for all users. In some examples, a user may select a particular format from a group of formats. In other examples, a different format may be automatically selected based on a user’s usage profile. For example, users that are in a management position may see different event types from users which may be dedicated to analyzing big data. In other examples, a format may be tailored to particular enterprises. Regardless of the format, the page generation service 220 generates a user-editable recap page within the content collaboration platform.

In response to a particular editable page being generated and accessible to the user (e.g., saved in a user-accessible location), a notification service 222 may generate a notification to a particular user associated with the particular editable page. The notification may include an email message that the user’s recap is ready to be viewed, reviewed, and/or edited. The email message may include a link to the generated page of the user’s profile. In some examples, the notification service may additionally and/or alternatively generate a notification pop-up in any platform within the enterprise’s suite, such as a content collaboration platform, an issue tracking platform, a project management platform, or a video messaging platform. The pop-up may be displayed as a window overlayed over a content panel of the content collaboration platform and may be operable to cause navigation to the particular editable page in response to a user selection of the notification. In some cases, the notification service 222 may be configured to send a text message to a user’s mobile phone including a link to the user’s recap which may be accessible to the user via a mobile browser.

The notification may include a preview of the editable page, such as a summary narrative of the content that is included in the editable page. The summary narrative may include preview objects that are generated from the editable objects generated for the editable page. The editable objects, in turn, may be based on at least a portion of row data from the aggregated data table corresponding to the particular user (e.g., first value, second value). The row data may be converted to editable objects and/or other graphical user elements to convey the recap narrative to the user. In some cases, a preview page may be displayed prior to displaying the editable recap page and may include a link which causes navigation to the editable page. In some examples, the preview page may include a portion of the particular editable page, a first user control configured to cause display of the particular editable page within the content collaboration platform, and a second user control configured to cause the particular editable page to publish.

In some cases, subsequent to the user selecting the link and in response to the particular user satisfying an authentication criteria, the particular editable page generated may be displayed within a user interface of the content collaboration platform. As discussed in FIG. 3C below, the graphical user interface may include a navigational panel including an array of tree elements arranged hierarchically. In some cases, each tree element of the array of tree elements may be selectable to cause display of a respective page (such as the particular editable page). The graphical user interface may further include a content region that is configured to display page content. For the editable page, the page content may include the editable objects. For example, a first editable object may be based on the first value and a second editable object may be based on the second value.

The editable page may be visible only to the user for which the recaps corresponds to. In response to a user input from the user, the page may be published. Accordingly, other users which have view permissions (e.g., satisfy a permissions scheme) for the page may access the particular user’s recap.

The embodiments depicted in FIGS. 3A–9 and the various alternatives thereof and variations thereto are presented, generally, for purposes of explanation, and to facilitate an understanding of various configurations and constructions of a system, such as described herein. However, it will be apparent to one skilled in the art that some of the specific details presented herein may not be required in order to practice a particular described embodiment, or an equivalent thereof.

Thus, it is understood that the foregoing and following descriptions of specific embodiments are presented for the limited purposes of illustration and description. These descriptions are not targeted to be exhaustive or to limit the disclosure to the precise forms recited herein. To the contrary, it will be apparent to one of ordinary skill in the art that many modifications and variations are possible in view of the above teachings.

FIGS. 3A–3E show example graphical user interfaces of the generated editable recap page for a particular user, including the preview window and the content collaboration platform user interface. The graphical user interfaces shown may be generated by a frontend application, which is a browser application operably coupled to a web-based backend application or platform. The graphical user interface can be rendered by a client device (e.g., client device 104, 106, 108 of FIG. 1), which may be a personal electronic device such as a laptop, desktop computer, tablet and the like. The client device can include a display with an active display area in which the graphical user interface can be rendered. The user interface can be rendered by operation of an instance of a frontend application associated with a backend application that collectively defines a software platform, as described herein. In some examples described herein, the graphical user interface may be displayed subsequent to, or in response to, an authentication of a user of the content collaboration platform.

FIG. 3A illustrates an example window 302 displayed within a user interface of a content collaboration platform 300a. The window 302 may be displayed to a user once the user’s recap page is generated. In this example, upon the first access of a user after the page is generated, the window 302 is displayed as an overlapping window (or full size window) over a content panel and/or a navigation panel of the content collaboration platform. In some examples, the window 302 may include a link 304 to a preview of the user’s generated page.

In response to a user clicking the link 304, a preview page 306 may be displayed within the window 302, as shown in the example graphical user interface 300b of FIG. 3B. The preview page 306 may include preview objects (e.g., based on the generated editable objects, based on the aggregated values) within a narrative summary section 307 (see, e.g., FIG. 2) for the particular user. For example, the preview objects on the narrative summary section 307 may include a narrative of number of pages worked on, number of pages viewed, number of comments left. In some examples, the preview page 306 may include all or most of the generated recap editable page for the user as it has been generated by the page generation service. In some cases, the preview page 306 may include a rendering of the generated page without links or other actionable user control. In other examples, the preview page 306 may include generated links to pages and other actionable user controls configured to redirect a user to the particular address in response to a user selection of the link and/or actionable user control.

In some cases, the preview page 306 may include a “publish” user control 308 and a “view draft” user control 310. In response to a user selection of the “publish” user control 308, the generated report is published in a predetermined location (e.g., a user’s personal space, a user recap space, and the like) of the content collaboration platform. Upon publishing, the user’s report page becomes accessible to other users’ accounts meeting a permissions condition for the page. In some cases, the user may tailor access requirements to view the recap page, such as selecting certain users or a subplurality of users that can view the page, matching another space’s view restrictions, and the like. In some examples, other users have read access to the user’s recap page. In other examples, the user may grant write access to certain users. For example, a user may grant write access to the user’s manager to bolster the impact of the recap page.

Alternatively, the user may select the “view draft” user control 310. In response to the user selection of the “view draft” user control 310, an editable recap page is displayed, such as the editable recap page shown in FIGS. 3C–3E. The editable recap page may be displayed within a content collaboration platform user interface 300c. The content collaboration platform user interface 300c may include a navigational panel 312 and a content panel 314, also referred to as a content region. The navigational panel 312 may be configured to facilitate navigation to different pages, spaces, blogs, and the like, within the content collaboration platform. In some cases, the navigational panel 312 is organized by space. Each space includes a page tree 316 having selectable tree elements, such as tree elements 318a and 318b. The selectable tree elements may be selectable to display a respective user-generated page in the content panel 314.

In some examples, the selectable tree elements (e.g., selectable tree elements 318a–b) may be arranged hierarchically. For example, the selectable tree elements may have a user-defined parent, child, grandchild relationship. For example, selectable tree element 318a may be a parent to selectable element 318b. The tree elements may include a short title and/or graphical elements that indicate the subject matter and type of content item associated with each respective element. Many of the tree elements may also be selected and moved within the page tree 316 to redefine a parent-child relationship between the respective tree elements. The collection of elements depicted in the navigational panel 312 maybe associated with a respective space, also referred to herein as a content space, page space, or document space. A space defines a collection of content items for which the space creator is the default administrator having default read, write, view, and control permissions with respect to all items within the space. Content and navigational panels may also be referred to herein as “panes,” “regions,” or “areas” of the graphical user interface.

The content panel 314 is configured to display electronic pages and documents. Generally, the content panel 314 may represent a substantial portion of the user interface of the content collaboration platform 300c. Electronic pages displayed in the content panel 314 may include user-generated items, such as text, figures, selectable graphical elements, embedded content, videos, comments, and the like. The content panel 314 may include toolbars to enable collaboration between users. For example, the content panel 314 may include an edit control 315a configured to launch a page editing interface, where a user may change the contents of the electronic page. In some cases, changes may be reflected upon publishing the edited content. In other cases, the edits may be displayed contemporaneously to other users accessing the page. The content panel 314 may also include a comment control 315b. The comment control 315b is configured to launch a comment interface, where a user can write, edit, and post comments. In some cases, the comment interface may include comment suggestions generated via a large language model. In some examples, the content panel 314 includes a video user control 315c, where a user may create or share videos via a video platform. In some cases, the content panel 314 may include or operate an editor that is configured to receive user-generated content, which is used to generate or modify the content of the document. As shown in FIG. 3C, the user-generated content or content may include what is referred to as structured rich text content, which may be formatted in accordance with a formatting scheme, such as HTML, XML, Atlassian Document Format (ADF), or other similar scheme or language. The particular schema may also be referred to as a platform-specific or editor-specific formatting schema. In some examples, the text content can also be displayed in line with hypertext, graphical elements and other content that is enabled by the editor instantiated by the frontend application within the content panel 314.

The graphical user interface may also include a control bar that includes an array of selectable controls for navigating to different spaces, documents, applications, or modules. The interface may also include controls for managing the content and interface modes of the graphical user interface. Generally, the graphical user interface provided by the frontend or client application may operate in one of a number of different modes. In a first mode, a user may create, edit or modify page or other digital content. This mode or state of the graphical user interface 300 may be referred to as an editor user interface, content-edit user interface, a page-edit user interface, or document-edit user interface. In a second or other mode, the user may view, search, comment on, or share the electronic document, page, or digital content. This mode or state of the graphical user interface may be referred to as a viewer user interface, content-view user interface, a page-view user interface, or document-view user interface. The graphical user interface may be implemented in a web browser client application using HTML, JavaScript, or other web-enabled protocol.

Generally, the graphical user interface may allow the user to create, edit, or otherwise modify user-generated content that is stored as an electronic page. The electronic page or other digital content may be rendered on a client device by the content collaboration service upon authorization/authentication of the user by the authentication/authorization service, and based on permissions granted to the user as validated according to a user profile associated with the user. Further, the content that is rendered in the content panel 314 may contain content extracted from or obtained from other content items having their own respective permissions profiles.

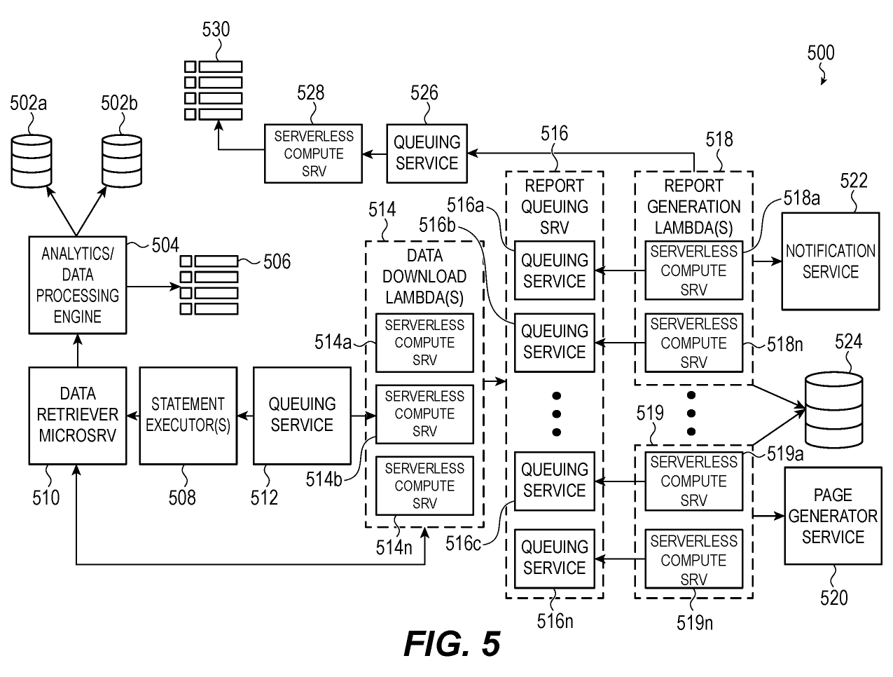

Back to the recap page, in some embodiments, the recap page may be distributed by categories of data events. For example, the recap page may include a first section 320 where editable objects showing which (and how many) data items the user edited. For example, the first section 320 may include an editable object showing an aggregated value for the number of electronic pages, whiteboards, databases, blogs, selectable graphical elements, and other data items the user created and/or edited within the content collaboration platform. As depicted, for example, a first editable object 320a may include a narrative of the number of pages edited and/or created by the user (e.g., data event type associated with a page creation and a page editing data event). As another example, a second editable object 302b may include a narrative of a number of graphical elements created and/or edited by the user. In some embodiments, as explained below in FIGS. 5–7, the first section 320 may include graphical elements operable to display data from data items from multiple platforms, such as issue items, projects, videos, and the like.

In some cases, the recap page may additionally or alternatively include a second section 322 including a list of pages created by the user. In particular, the second section 322 may include a list of graphical elements, representing pages, created by the user. The list of pages represented by the graphical elements may be selected from a plurality of pages associated with the user. This selection may be based on a criteria. For example, a predetermined number of pages may be selected based on a threshold number of views, reactions, and/or comments from other users. In some cases, the selected pages may be ranked in a decreasing order, from most reactions and/or comments to less reactions and/or comments. Each of the selected pages may be displayed in the user interface 300c as a selectable graphical element which may include a page title and other metadata. For example, graphical element 324 associated with a page may include an avatar, an emoji, and the page’s title. The graphical element 324 may be selectable by a user to cause display of the page associated with the graphical element 324.

In some cases, the second section 322 may further include aggregated values associated with each of the selected pages. For example, an aggregated value representing number of reactions and comments 325 may be displayed adjacent to (e.g., under, next to) the graphical element 324. In this case, the number of reactions and the number of comments may be a respective data event type. In some embodiments, the selected pages for the second section 322 may be based on the aggregated value shown adjacent to the graphical element 324. In this example, the selected pages are ranked according to a combined number of reactions and comments.

According to some embodiments, the recap page may additionally or alternatively include a third section 326. The third section 326 may include a list of pages which the user revised, each page represented by a respective graphical element, such as graphical element 327. The list of pages that the user revised may be selected for the recap based on word count revised, percentage of the page revised, number of revisions, time spent revising the page, or other criteria that is computed using aggregated data events. Each of the selectable graphical elements in the third section 326 may be selectable to cause navigation to the selected page in response to a user click to the selectable graphical element. In some cases, an authentication service may check the credentials of the user viewing the page. If the credentials for the user viewing the page fails to satisfy an authentication criteria, a “request access” 328 or other flags may be displayed adjacent to the graphical element 327 to indicate that the user cannot access the electronic page associated with the graphical element. In some cases the “request access” 328 flag may be selectable to cause display of a window within the content panel configured to request access without navigating away from the page.

FIG. 3D shows additional and/or alternative content which may be included in the recap page (user interface 300d). The recap page may include a fourth section 330 that includes a list of spaces, such as space 332. As discussed above, spaces are containers in which pages are stored and in which the stored pages are organized hierarchically. Generally, spaces may be used to organize all pages in a project, pages related to a particular group, and the like. The list of spaces shown in the fourth section 330 may be selected from a plurality of spaces according to a selection criteria. The selection criteria may be based on an aggregated metric extracted from the data events. For example, the selection criteria may be based on number of pages created in each of the spaces, time spent in each of the spaces, a combined number of revised pages and created pages, or the like. Each space of the list of spaces may be displayed as a graphical element operable to cause navigation to the selected space.

In some embodiments, the fourth section 330 includes a collapsible area 334 that includes additional data showing which pages for each of the spaces the user collaborated on. For example, for space 332, a graphical element 336 associated with a page is displayed below the space. In some embodiments, the graphical elements may visually include the hierarchical arrangement of the associated page as its counterpart tree element (e.g., as displayed in the navigational panel). For example, a parent / child relationship of one or more pages may be shown as tabbed entries, similar to the page tree.

The recap page may additionally or alternatively include a fifth section 338. In some examples, the fifth section 338 is configured to show a list of users, such as user 340, that the particular user collaborated with. The list of users may be selected according to an interaction criteria, such as number of communications between the users, number of common pages or spaces, similar work roles, and the like. Generally, the interaction criteria may be based on one or more data event types over a predetermined period of time aggregated by the analytics and processing engine of FIG. 2. In some cases, a total number of users 342 (aggregated from data events) with whom the particular user interacted is displayed in the fifth section.

FIG. 3E shows additional and/or alternative content which may be included in the recap page (user interface 300e). As depicted, the recap editable page may include a sixth section 344 that includes a user “personality” 346 selected from a list of “personalities” based on the data events and its aggregated values. The user “personality” 346 may be based on the type of user, such as management, developer, or the like and the usage profile of the user within the content collaboration platform. In some cases the user “personality” 346 may be based on the number of pages, amount of time, or similar that the user spent in the platform. In some cases, the selected user “personality” 346 may be used as a guidance to evaluate user performance, may be used as a tiered system to distribute awards or other incentives, may be used as team building, or to identify areas of improvement for the users, as some examples.

It should be noted that any of the first through sixth sections described above may be included, omitted, or modified within the recap editable page. For example, a user may add more details to one or more of the sections to provide more context for the work the user did within the predetermined period of time, as an example. In some cases, a user may choose to omit one or more sections from the user’s recap report. While the recap report is an editable page, the aggregated values included within the editable objects may be restricted from editing. For example, a user may be restricted from changing a number of pages edited from 38 to 100. In some cases, a user may access the user’s data used to build the user’s recap report as a way to audit the data displayed.

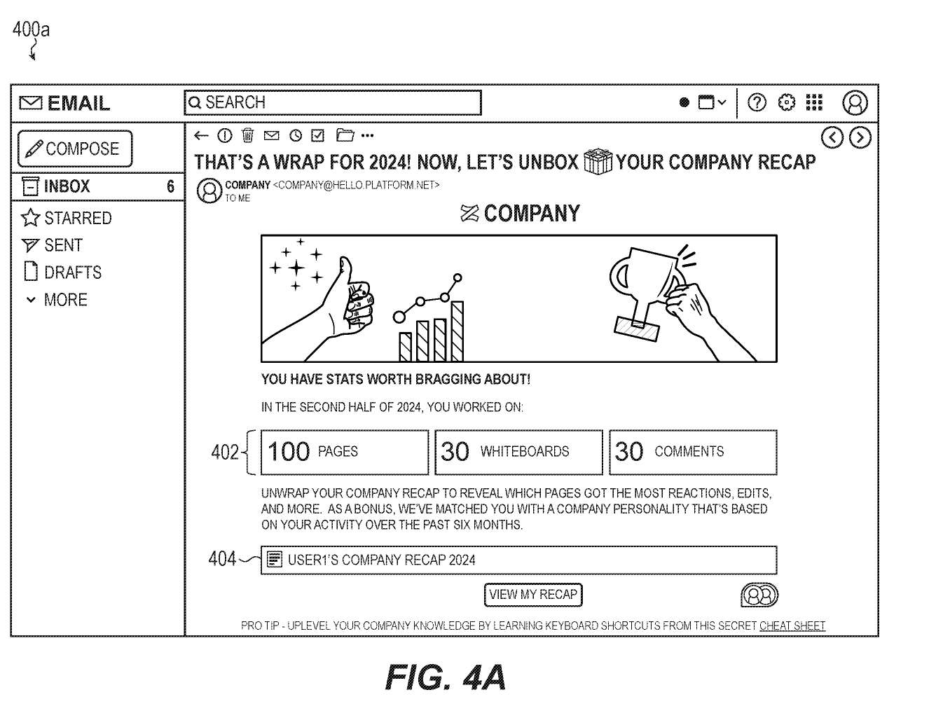

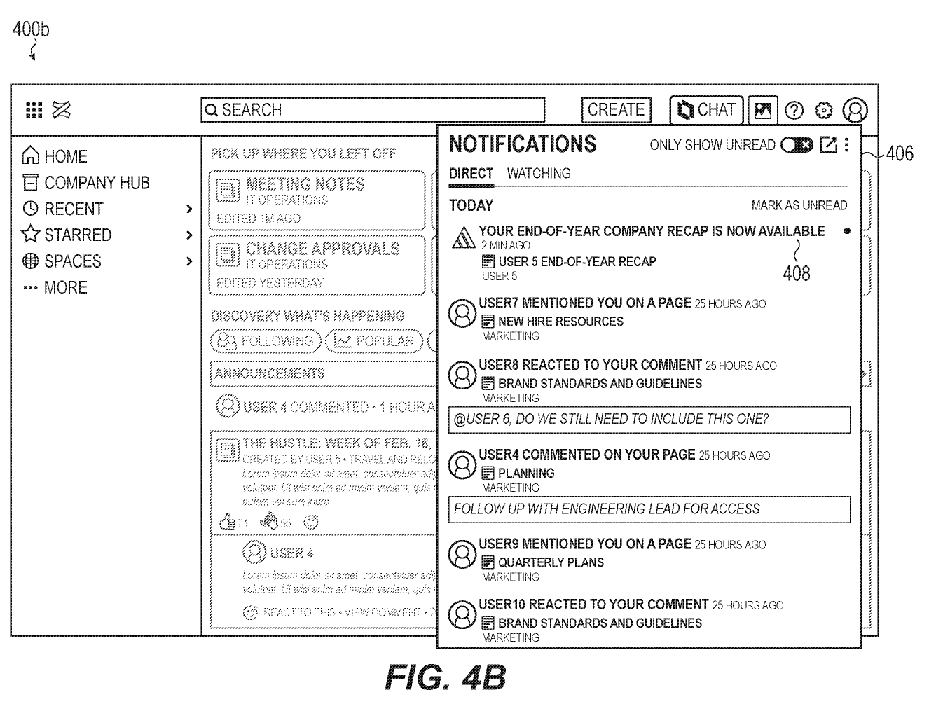

As discussed for FIG. 2, the system may include a notification service 222 configured to generate notifications to each user once the recap page has been generated. FIGS. 4A–4B depict example notifications of the generated recap report received by each user. FIG. 4A shows an example email notification 400a that may be received by a particular user. The notification may include a summary portion 402 of the user’s aggregated data. The summary portion 402 may be an executive summary or a high level overview of the aggregated data events available on the user’s recap page. In some cases, the email notification 400a may include a graphical element 404 including metadata for the recap page. The graphical element 404 may be configured to redirect the user to an instance of the content collaboration platform (e.g., accessed via a web browser).

FIG. 4B depicts another example of a user interface 400b of a content collaboration platform including a notification. In this example, the content collaboration platform includes a window 406 which overlies a content panel of the content collaboration platform. The window 406 may include a plurality of notifications, including notification 408. Notification 408 includes information that the recap page for the user is available. In some embodiments, notification 408 includes a link operable to navigate the user to the recap page.

The user interfaces described above depict an editable recap page in a content collaboration platform. It should be noted that the systems and methods disclosed may include other platforms. For example, a recap item, such as the recap page described above in FIGS. 3A–4B, may be generated within the content collaboration platform and include data events from other federated platforms, such as issue tracking platforms, project management platforms, developer platforms, video generation platforms, and the like. In some cases, a recap item may be generated for each individual platform, such as a recap issue item including data events from the issue tracking platform. In other examples, a combined platform(s) recap item may be generated in one or some of each of the platforms, including data events from multiple platforms.

FIG. 5 shows a simplified diagram of a system 500 configured to generate a recap item using data events from multiple platforms (e.g., a content collaboration platform, an issue tracking platform, a developer platform, a project management platform, a video creation platform, and the like). The recap item may be saved as an editable recap page in a content collaboration platform, an editable recap issue item in an issue tracking platform, and the like. As depicted, data events from multiple platforms may be stored in one or more data lakes, such as data lake 502a and data lake 502b. For example, data events from a content collaboration platform may be stored in data lake 502a and data events from an issue tracking platform may be stored in data lake 502b. While two data lakes are shown, it should be noted that data events may be stored in any number of data lakes or in a single data lake.

Data lakes 502a and 502b may be communicably coupled to an analytics and data processing engine 504. The analytics and data processing engine 504 may be configured to pull data events from the multiple data lakes, aggregate, and organize the data into a data table 506. In some cases, a respective aggregated data table may be generated from the data events extracted from each of the data lakes 502a and 502b, and a combined data table 506 may be generated from each of the respective aggregated data tables. In some cases, each user may have different user IDs for each of the multiple platforms. In this example, the data events may include a global user ID mapping each of the multiple user IDs to the user.

As discussed as to the analytics and data processing engine 204 in FIG. 2 above, in some examples, due to the large amount of data, the analytics and data processing engine 504 may be a distributed computing environment capable or executing a set of tasks in parallel. The engine 504 may divide a job in stages, where each stage includes a plurality of tasks that are executed in parallel. The analytics and data processing engine 504 may include a cluster manager configured to allocate resources to execute the job. In some cases, the aggregation and other computational tasks (e.g., map, reduce, join, and the like) may be performed using one or more Application Programming Interfaces (API). The analytics and data processing engine 504 is configured to store the aggregated table 506 in a temporary store. The aggregated table 506 may be associated with a unique job ID. In some cases, the aggregated table 206 includes data from a predetermined period of time, such as 6 months, 1 year, 10 years, and the like. In some cases, each column of the aggregated table 506 includes data from the multiple platforms for a single user and the number of rows represents the number of users in the multiple platforms. It may be appreciated that other table configurations are envisioned.

Due to the size of aggregated table—in the order of millions, tens of millions, billions, or the like,—a statement executor 508 may be executed to query whether the job of aggregating the data events into table 506 is complete. In particular, the statement executor 208 may be communicably coupled to a data retriever microservice 510 which, in turn, is communicatively coupled to the analytics and data processing engine 504. Via one or more API calls, the data retriever microservice 510 may be configured to check authentication, retrieve the data, and retrieve a job status from the analytics and data processing engine 504. The statement executor 508 may be configured to receive updates about the completion of the aggregated table 506 using the job ID as input to the data retrieve microservice. In some cases, the statement executor 508 is a lambda which queries whether the job is complete periodically. In some cases, the statement executor 508 continues the query until it receives a message that the job, e.g., preparing the aggregated table 506, was successful.

The aggregated table 506 is chunked and/or partitioned into a plurality of data chunks (e.g., in the order of thousands, tens of thousands, and the like), depending on the number of users, the number of platforms, the amount of data events pulled and aggregated for each user and platform, and so on. Each of the plurality data chunks may be associated with a chunk index that can be retrieved and queued as a separate event by a queuing service 512. Similar to queuing service 212 from FIG. 5, the queuing service 512 may be a message queuing service deployed in a cloud computing environment and may support multiple types of queues.

A data download lambda 514, which may include a first serverless compute service 514a, a second serverless compute service 514b, up to an nth serverless compute service 514n, is communicatively coupled to the queuing service 512 and invoked when the data chunks are ready to download. The data download lambda 514 is configured to download each data chunk in parallel and/or asynchronously. Each chunk index may be enqueued as a separate chunk download event, the data download lambda 514 then obtains each chunk download event from the data retriever microservice 510. In some cases, recap event messages are constructed and distributed to one or more report queuing service(s) 516. The report queuing service(s) may include a first queuing service 516a, a second queuing service 516b, and third queuing service 516c, up to an nth queuing service 516n. The queuing service may employ any suitable queuing algorithm, such as round-robin, FIFO, priority, PRIO, QFQ, and the like.

In some embodiments, a report generation lambda 518 and 519 may be configured to retrieve the recap events in batches from the report queuing service(s) 516. Each report generation lambda 518 and 519 may include queuing service(s) 518a–n and 519a–n, respectively. Next, a database 524 may be used to verify if each of the user records have been processed. For user records that have not been processed, a recap item (e.g., an editable recap page, a recap issue item, or the like) is generated for each user via the page generator service 520. Once the recap item is generated, the user is notified via a notification service 522. Successfully-generated recap items are tracked in a queuing service 526. A serverless compute service 528 may be configured to receive the tracked events and store the tracked events in a table 530.

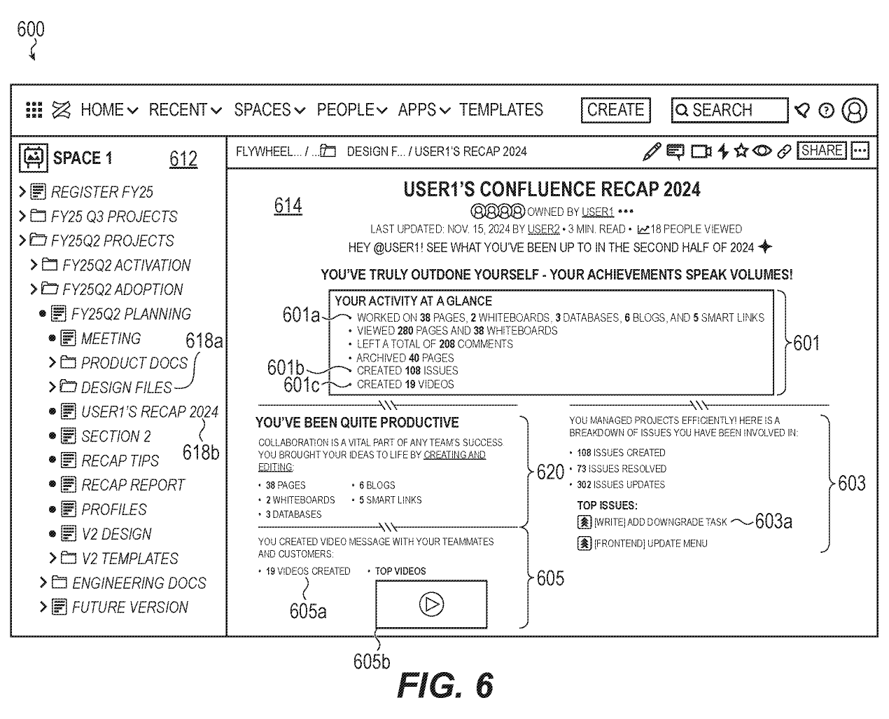

FIG. 6 shows an example user interface 600 of a multi-platform recap page displayed in a content collaboration platform. In this view, the navigational panel 612 and the content panel 614 may be the same or similar to the navigational panel 312 and the content panel 314 as discussed in FIG. 3C above. Furthermore, the navigational panel 612 may include a page tree 616 that includes selectable tree elements 618a and 618b that may be arranged in a parent / child / grandchild relationship, as discussed in FIG. 3C above.

The multi-platform recap page may include a summary section 601, similar to the summary section 307 discussed in FIG. 3C. The summary section 601 may include editable objects generated based on aggregated values from data events from the content collaboration platform (e.g., bullet point 601a), aggregated values from data events from the issue tracking platform (e.g., bullet point 601b), aggregated values from data events from a video messaging platform (e.g., bullet point 601c), and/or data events from other federated platforms. In some cases, the summary section 601 is generated using data event types from a predetermined list. In some examples, the summary section 601 is generated by selecting editable objects associated with particular data event types from each of the platform using a selection criteria. The selection criteria may be based on most usage by the user, largest aggregated numbers, and the like.

The multi-platform recap page may also include an issue tracking platform section 603. The issue tracking platform section 603 may include editable objects generated from aggregated values computed using data events from the issue tracking platform, such as issue items created, issues resolved, and issues updated. In some cases, the issue tracking platform section 603 may include a graphical element 603a operable to cause navigation to the issue tracking platform. The graphical element 603a may include metadata from the issue item, such as issue title, issue status, and the like. An authentication server may flag to access restrictions to users failing to satisfy an authentication criteria.

The multi-platform recap page may also include a video messaging section 605. The video messaging section 605 may include editable objects based on aggregated data events collected by the video messaging platform, such as data item 605a showing the number of videos created by the user. In some examples, the video messaging section 605 may include a video 605b. In some cases, the video 605b may be viewable from the content collaboration platform. In other examples, the video 605b may be a link configured to cause navigation to the video messaging platform. Similar to the issue tracking platform issue items, the graphical user interface, in communication with one or more of an authentication service and a permissions profile for the user, may flag to a particular user viewing the recap page when the particular user does not have access to the video.

The multi-platform recap page may also include a content collaboration platform section 620, which may include aggregated data events from the content collaboration platform, such as those described in FIGS. 3C–3E.

It should be noted that while the multi-platform recap page depicted in FIG. 6 shows different sections for each of the different platforms, the multi-platform recap page may be arranged in any suitable way. As a non-exhaustive example, the multi-platform recap page may be organized by project and may include aggregated values computed from data events from the content collaboration platform associated with the project, whiteboards associated with the project, issue items linked to the project, and the like. In some embodiments, the multi-platform recap page may be organized by “type.” For example, items (e.g., pages, issue items, blogs, videos) created may be shown in a created section, items revised may be shown in a separate section, and so on.

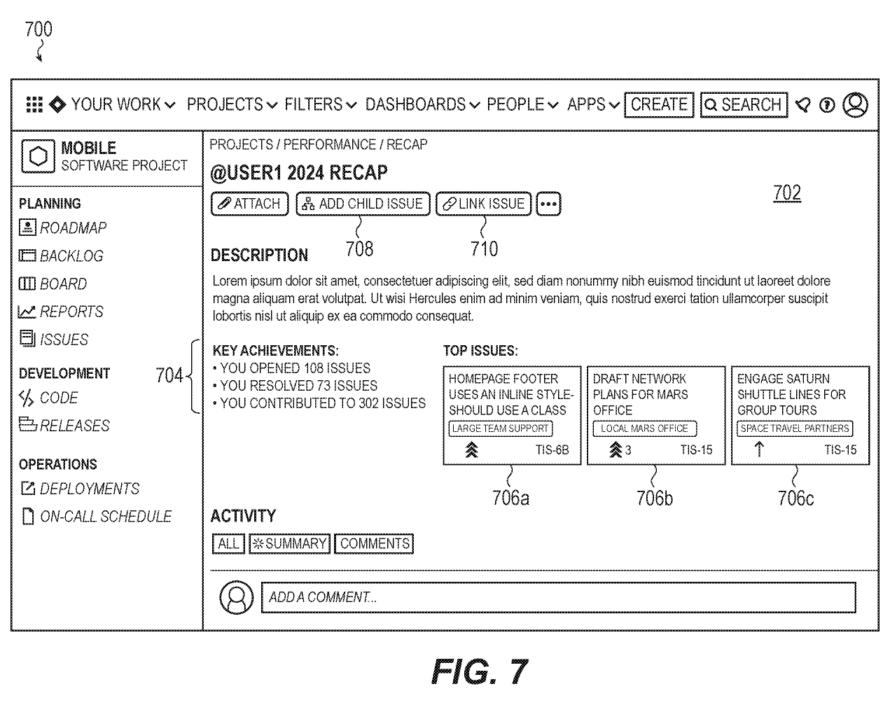

In some examples a recap item may be created for each specific platform. FIG. 7 shows an example of a user interface 700 for an issue tracking platform presenting an example recap issue item 702. The recap issue item 702 may be an editable issue item saved within a project associated with each particular user. The recap issue item 702 may be saved as a draft issue item and may be created in response to an input from the particular user for which the recap was created.

The recap issue item 702 may include a summary section 704. The summary section 704 may include a list of aggregated data events displayed by data event types. For example, as depicted in FIG. 7, the summary section 704 includes opened issues, resolved issues, edited issues, and the like. In some embodiments, the recap issue item 702 may include a list of issues, such as issues 706a–c. Each of the issues 706a–c may be selectable issue items operable to cause navigation to the selected issue item. In some cases, each issue 706a–c may be displayed as an issue card, including issue metadata such as title, project, tag, issue ID, status, and the like. The “top issues” shown may be selected from a list of issues associated with the user in accordance with an issue selection criteria. For example, the issue items may be selected based on an importance criteria. In some cases, the issue items may be selected based on user involvement in the issue (e.g., creation, editing, adding child issues, resolving, and the like). In some cases, the issue items may be selected from a list of closed issues resolved by the user.

In some examples, the editable recap issue 702 may include an add child issue user control 708. In response to a user selection of the add child issue user control 708, the user may link one or more issues to the recap issue item 702, such as the issues 706a–c displayed in the recap issue item, other recap issue items (e.g., a team recap issue item, a project recap issue item, a previous recap issue item, and the like), or any suitable issue item. In some cases, the editable recap issue 702 may also include a link issue user control 710 that is operable to link another issue to the recap issue item 702, such as those described above.

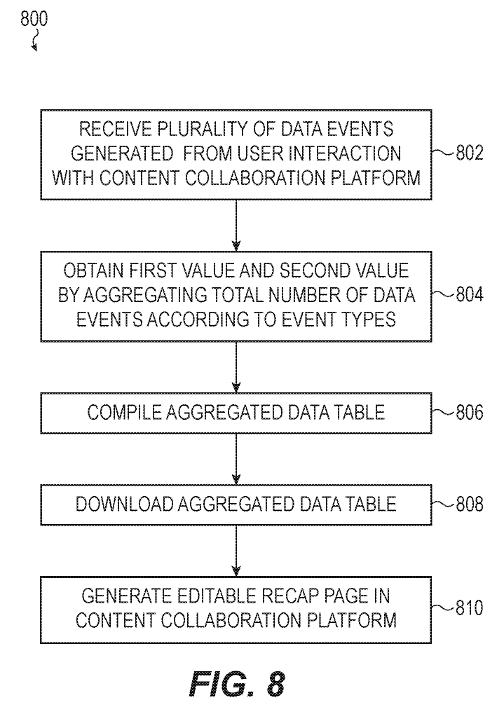

FIG. 8 depicts a simplified method 800 for generating an editable recap page in the content collaboration platform. At operation 802, a plurality of data events from the content collaboration platform may be received. In some cases, as explained in FIG. 2 above, the plurality of data events may be stored in one or more data lakes. Each data event is associated with a user ID (e.g., originated by the user associated with the user ID interacting with the content collaboration platform). The data events may have a data event type, depending on the type of interaction (page view, page creation, scroll, and the like).

At operation 802, the data events are aggregated or processed. In particular, based on a subset of data events having a first data event type, the number of data events may be aggregated to obtain a first value. Similarly, based on a different subset of data events having a second data event type, the number of data events may be aggregated to obtain a second value.

As values, user IDs, page IDs, and the like are aggregated, selected, or identified, at operation 806, an aggregated data table is compiled. The aggregated data table may contain at least the user ID, the first value, and the second value.

At operation 808, the compiled data table is updated. Depending on the size of the aggregated data table, the data table may be downloaded in chunks. In some cases, the download operation is executed via a serverless compute service, which may be coupled to a gateway that in turn can communicate to the data lake and/or other services.

At operation 810, an editable recap page is generated within the content collaboration platform. The editable recap page may leverage the first value and the second value to capture a user’s work and/or usage of the platform over the predefined period of time. In some embodiments, one or more notifications may be generated to notify the user that their recap is ready. Once authenticated, the user may access their particular editable recap page and elect to publish the page, thereby making the page viewable to other users.

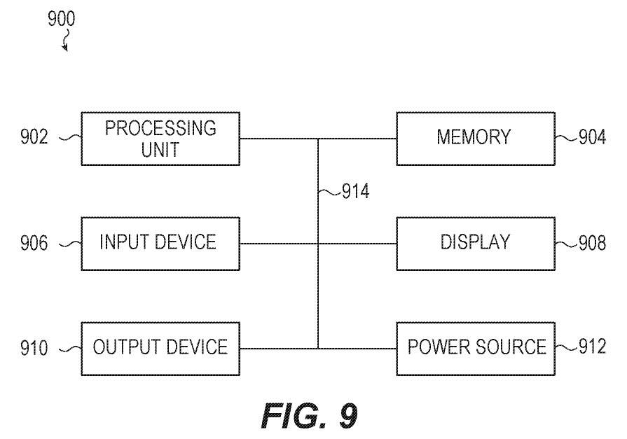

FIG. 9 shows a sample electrical block diagram of an electronic device 900 that may perform the operations described herein. The electronic device 900 may in some cases take the form of any of the electronic devices described with reference to FIG. 1, including client devices, and/or servers or other computing devices associated with the collaboration system 100. The electronic device 900 can include one or more of a processing unit 902, a memory 904 or storage device, input devices 906, a display 908, output devices 910, and a power source 912. In some cases, various implementations of the electronic device 900 may lack some or all of these components and/or include additional or alternative components.

The processing unit 902 can control some or all of the operations of the electronic device 900. The processing unit 902 can communicate, either directly or indirectly, with some or all of the components of the electronic device 900. For example, a system bus or other communication mechanism 914 can provide communication between the processing unit 902, the power source 912, the memory 904, the input device(s) 906, and the output device(s) 910.

The processing unit 902 can be implemented as any electronic device capable of processing, receiving, or transmitting data or instructions. For example, the processing unit 902 can be a microprocessor, a central processing unit (CPU), an application-specific integrated circuit (ASIC), a digital signal processor (DSP), or combinations of such devices. As described herein, the term "processing unit" is meant to encompass a single processor or processing unit, multiple processors, multiple processing units, or other suitably configured computing element or elements.

It should be noted that the components of the electronic device 900 can be controlled by multiple processing units. For example, select components of the electronic device 900 (e.g., an input device 906) may be controlled by a first processing unit and other components of the electronic device 900 (e.g., the display 908) may be controlled by a second processing unit, where the first and second processing units may or may not be in communication with each other.

The power source 912 can be implemented with any device capable of providing energy to the electronic device 900. For example, the power source 912 may be one or more batteries or rechargeable batteries. Additionally, or alternatively, the power source 912 can be a power connector or power cord that connects the electronic device 900 to another power source, such as a wall outlet.

The memory 904 can store electronic data that can be used by the electronic device 900. For example, the memory 904 can store electronic data or content such as, for example, audio and video files, documents and applications, device settings and user preferences, timing signals, control signals, and data structures or databases. The memory 904 can be configured as any type of memory. By way of example only, the memory 904 can be implemented as random access memory, read-only memory, flash memory, removable memory, other types of storage elements, or combinations of such devices.

In various embodiments, the display 908 provides a graphical output, for example associated with an operating system, user interface, and/or applications of the electronic device 900 (e.g., a chat user interface, an issue-tracking user interface, an issue-discovery user interface, etc.). In one embodiment, the display 908 includes one or more sensors and is configured as a touch-sensitive (e.g., single-touch, multi-touch) and/or force-sensitive display to receive inputs from a user. For example, the display 908 may be integrated with a touch sensor (e.g., a capacitive touch sensor) and/or a force sensor to provide a touch- and/or force-sensitive display. The display 908 is operably coupled to the processing unit 902 of the electronic device 900.

The display 908 can be implemented with any suitable technology, including, but not limited to, liquid crystal display (LCD) technology, light emitting diode (LED) technology, organic light-emitting display (OLED) technology, organic electroluminescence (OEL) technology, or another type of display technology. In some cases, the display 908 is positioned beneath and viewable through a cover that forms at least a portion of an enclosure of the electronic device 900.

In various embodiments, the input devices 906 may include any suitable components for detecting inputs. Examples of input devices 906 include light sensors, temperature sensors, audio sensors (e.g., microphones), optical or visual sensors (e.g., cameras, visible light sensors, or invisible light sensors), proximity sensors, touch sensors, force sensors, mechanical devices (e.g., crowns, switches, buttons, or keys), vibration sensors, orientation sensors, motion sensors (e.g., accelerometers or velocity sensors), location sensors (e.g., global positioning system (GPS) devices), thermal sensors, communication devices (e.g., wired or wireless communication devices), resistive sensors, magnetic sensors, electroactive polymers (EAPs), strain gauges, electrodes, and so on, or some combination thereof. Each input device 906 may be configured to detect one or more particular types of input and provide a signal (e.g., an input signal) corresponding to the detected input. The signal may be provided, for example, to the processing unit 902.

As discussed above, in some cases, the input device(s) 906 includes a touch sensor (e.g., a capacitive touch sensor) integrated with the display 908 to provide a touch-sensitive display. Similarly, in some cases, the input device(s) 906 includes a force sensor (e.g., a capacitive force sensor) integrated with the display 908 to provide a force-sensitive display.

The output devices 910 may include any suitable components for providing outputs. Examples of output devices 910 include light emitters, audio output devices (e.g., speakers), visual output devices (e.g., lights or displays), tactile output devices (e.g., haptic output devices), communication devices (e.g., wired or wireless communication devices), and so on, or some combination thereof. Each output device 910 may be configured to receive one or more signals (e.g., an output signal provided by the processing unit 902) and provide an output corresponding to the signal.

In some cases, input devices 906 and output devices 910 are implemented together as a single device. For example, an input/output device or port can transmit electronic signals via a communications network, such as a wireless and/or wired network connection. Examples of wireless and wired network connections include, but are not limited to, cellular, Wi-Fi, Bluetooth, IR, and Ethernet connections.

The processing unit 902 may be operably coupled to the input devices 906 and the output devices 910. The processing unit 902 may be adapted to exchange signals with the input devices 906 and the output devices 910. For example, the processing unit 902 may receive an input signal from an input device 906 that corresponds to an input detected by the input device 906. The processing unit 902 may interpret the received input signal to determine whether to provide and/or change one or more outputs in response to the input signal. The processing unit 902 may then send an output signal to one or more of the output devices 910, to provide and/or change outputs as appropriate.

As used herein, the phrase “at least one of” preceding a series of items, with the term “and” or “or” to separate any of the items, modifies the list as a whole, rather than each member of the list. The phrase “at least one of” does not require selection of at least one of each item listed; rather, the phrase allows a meaning that includes at a minimum one of any of the items, and/or at a minimum one of any combination of the items, and/or at a minimum one of each of the items. By way of example, the phrases “at least one of A, B, and C” or “at least one of A, B, or C” each refer to only A, only B, or only C; any combination of A, B, and C; and/or one or more of each of A, B, and C. Similarly, it may be appreciated that an order of elements presented for a conjunctive or disjunctive list provided herein should not be construed as limiting the disclosure to only that order provided.

One may appreciate that although many embodiments are disclosed above, that the operations and steps presented with respect to methods and techniques described herein are meant as exemplary and accordingly are not exhaustive. One may further appreciate that alternate step order or fewer or additional operations may be required or desired for particular embodiments.

Although the disclosure above is described in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the some embodiments of the invention, whether or not such embodiments are described and whether or not such features are presented as being a part of a described embodiment. Thus, the breadth and scope of the present invention should not be limited by any of the above-described exemplary embodiments but is instead defined by the claims herein presented.

In addition, it is understood that organizations and/or entities responsible for the access, aggregation, validation, analysis, disclosure, transfer, storage, or other use of private data such as described herein will preferably comply with published and industry-established privacy, data, and network security policies and practices. For example, it is understood that data and/or information obtained from remote or local data sources, only on informed consent of the subject of that data and/or information, should be accessed aggregated only for legitimate, agreed-upon, and reasonable uses.

As used herein, the term “computing resource” (along with other similar terms and phrases, including, but not limited to, “computing device” and “computing network”) refers to any physical and/or virtual electronic device or machine component, or set or group of interconnected and/or communicably coupled physical and/or virtual electronic devices or machine components, suitable to execute or cause to be executed one or more arithmetic or logical operations on digital data.

Example computing resources contemplated herein include, but are not limited to: single or multi-core processors; single or multi-thread processors; purpose-configured co-processors (e.g., graphics processing units, motion processing units, sensor processing units, and the like); volatile or non-volatile memory; application-specific integrated circuits; field-programmable gate arrays; input/output devices and systems and components thereof (e.g., keyboards, mice, trackpads, generic human interface devices, video cameras, microphones, speakers, and the like); networking appliances and systems and components thereof (e.g., routers, switches, firewalls, packet shapers, content filters, network interface controllers or cards, access points, modems, and the like); embedded devices and systems and components thereof (e.g., system(s)-on-chip, Internet-of-Things devices, and the like); industrial control or automation devices and systems and components thereof (e.g., programmable logic controllers, programmable relays, supervisory control and data acquisition controllers, discrete controllers, and the like); vehicle or aeronautical control devices systems and components thereof (e.g., navigation devices, safety devices or controllers, security devices, and the like); corporate or business infrastructure devices or appliances (e.g., private branch exchange devices, voice-over internet protocol hosts and controllers, end-user terminals, and the like); personal electronic devices and systems and components thereof (e.g., cellular phones, tablet computers, desktop computers, laptop computers, wearable devices); personal electronic devices and accessories thereof (e.g., peripheral input devices, wearable devices, implantable devices, medical devices and so on); and so on. It may be appreciated that the foregoing examples are not exhaustive.

Example information can include, but may not be limited to: personal identification information (e.g., names, social security numbers, telephone numbers, email addresses, physical addresses, driver’s license information, passport numbers, and so on); identity documents (e.g., drivers licenses, passports, government identification cards or credentials, and so on);protected health information (e.g., medical records, dental records, and so on); financial, banking, credit, or debt information; third-party service account information (e.g., usernames, passwords, social medial handles, and so on); encrypted or unencrypted files; database files; network connection logs; shell history; filesystem files; libraries, frameworks, and binaries; registry entries; settings files; executing processes; hardware vendors, versions, and/or information associated with the compromised computing resource; installed applications or services; password hashes; idle time, uptime, and/or last login time; document files; product renderings; presentation files; image files; customer information; configuration files; passwords; and so on. It may be appreciated that the foregoing examples are not exhaustive.

The foregoing examples and description of instances of purpose-configured software, whether accessible via API as a request-response service, an event-driven service, or whether configured as a self-contained data processing service are understood as not exhaustive. In other words, a person of skill in the art may appreciate that the various functions and operations of a system such as described herein can be implemented in a number of suitable ways, developed leveraging any number of suitable libraries, frameworks, first or third-party APIs, local or remote databases (whether relational, NoSQL, or other architectures, or a combination thereof), programming languages, software design techniques (e.g., procedural, asynchronous, event-driven, and so on or any combination thereof), and so on. The various functions described herein can be implemented in the same manner (as one example, leveraging a common language and/or design), or in different ways. In many embodiments, functions of a system described herein are implemented as discrete microservices, which may be containerized or executed/instantiated leveraging a discrete virtual machine, that are only responsive to authenticated API requests from other microservices of the same system. Similarly, each microservice may be configured to provide data output and receive data input across an encrypted data channel. In some cases, each microservice may be configured to store its own data in a dedicated encrypted database; in others, microservices can store encrypted data in a common database; whether such data is stored in tables shared by multiple microservices or whether microservices may leverage independent and separate tables/schemas can vary from embodiment to embodiment. As a result of these described and other equivalent architectures, it may be appreciated that a system such as described herein can be implemented in a number of suitable ways. For simplicity of description, many embodiments that follow are described in reference an implementation in which discrete functions of the system are implemented as discrete microservices. It is appreciated that this is merely one possible implementation.

It may be further appreciated that a request-response RESTful system implemented in whole or in part over cloud infrastructure is merely one example architecture of a system as described herein. More broadly, a system as described herein can include a frontend and a backend configured to communicably couple and to cooperate in order to execute one or more operations or functions as described herein. In particular, a frontend may be an instance of software executing by cooperation of a processor and memory of a client device. Similarly, a backend may be an instance of software and/or a collection of instantiated software services (e.g., microservices) each executing by cooperation of a processor resource and memory resources allocated to each respective software service or software instance. Backend software instances can be configured to expose one or more endpoints that frontend software instances can be configured to leverage to exchange structured data with the backend instances. The backend instances can be instantiated over first-party or third-party infrastructure which can include one or more physical processors and physical memory devices. The physical resources can cooperate to abstract one or more virtual processing and/or memory resources that in turn can be used to instantiate the backend instances.

The backend and the frontend software instances can communicate over any suitable communication protocol or set of protocols to exchange structured data. The frontend can, in some cases, include a graphical user interface rendered on a display of a client device, such as a laptop computer, desktop computer, or personal phone. In some cases, the frontend may be a browser application and the graphical user interface may be rendered by a browser engine thereof in response to receiving HTML served from the backend instance or a microservice thereof.

As described herein, the term “processor” refers to any software and/or hardware-implemented data processing device or circuit physically and/or structurally configured to instantiate one or more classes or objects that are purpose-configured to perform specific transformations of data including operations represented as code and/or instructions included in a program that can be stored within, and accessed from, a memory. This term is meant to encompass a single processor or processing unit, multiple processors, multiple processing units, analog or digital circuits, or other suitably configured computing element or combination of elements.

As described herein, the term “memory” refers to any software and/or hardware-implemented data storage device or circuit physically and/or structurally configured to store data in a non-transitory or otherwise nonvolatile, durable manner. This term is meant to encompass memory devices, memory device arrays (e.g., redundant arrays and/or distributed storage systems), electronic memory, magnetic memory, optical memory, and so on.

In other examples, the data can conform to a particular data transfer protocol – whether proprietary or standardized – such as, but not limited to: universal serial bus (typically referred to as “USB”); peripheral component interconnect express standard (typically referred to as “PCIe”); controller area network (typically referred to as “CAN”); on-board diagnostics (typically referred to as “OBD” or “OBD-II”); serial peripheral interface bus (typically referred to as “SPI Bus”); high-definition multimedia interface (typically referred to as “HDMI”); ethernet; integrated drive electronics (typically referred to as “IDE”); serial or parallel advanced technology attachment (typically referred to as “SATA” or “PATA”); inter-integrated circuit bus (typically referred to as “I2C”); and so on. In other cases, more than one protocol, encoding, and/or encryption technique or technology can be used in parallel.

What is claimed is:

1. A method for generating a plurality of editable pages in a content collaboration platform, the plurality of editable pages including a respective recap of a respective user’s usage of at least two platforms for a predetermined period of time, the method comprising:
sending a request to compile a data table based on data events from the at least two platforms, the request comprising:
the predetermined period of time for the data events; and
a list of data event types to be aggregated to compute a corresponding plurality of aggregated values for each user of a plurality of users;
in response to the request:
aggregating a corresponding plurality of values for each user of the plurality of users based on a number of data events, each aggregated value from the plurality of values corresponding to a respective data event type, the plurality of users including a first plurality of users from a first tenant and a second plurality of users from a second tenant, the corresponding plurality of aggregated values for each user of the plurality of users stored in the data table;
subsequent to generating the data table, chunking the data table into a plurality of data chunks, each data chunk of the plurality of data chunks comprising data from at least two tenants;
downloading the plurality of data chunks, each data chunk downloaded by a respective serverless compute service;
from the plurality of data chunks, constructing a respective recap editable page comprising a corresponding plurality of editable objects generated based on the corresponding plurality of aggregated values associated with each respective user of the plurality of users;
in response to a user input from a particular user, cause display of a particular recap editable page in a graphical user interface of the content collaboration platform, the graphical user interface comprising:
a navigation panel including an array of tree elements arranged hierarchically, each tree element of the array of tree elements selectable to cause display of a respective page; and
a content region configured to display the particular recap editable page, the particular editable page comprising:
the corresponding plurality of editable objects associated with the particular user; and
a selectable graphical element corresponding to a first page created by the particular user, the selectable graphical element configured to cause navigation to the first page, the first page associated with a plurality of first page data events generated from a plurality of interactions of the particular user with the first page.

2. The method of claim 1, wherein:
each data chunk comprises a respective chunk index;
the respective serverless compute service is a respective first lambda of a plurality of first lambdas;
the method further comprises:
in response to downloading a particular data chunk from the plurality of data chunks, generating a particular event in a chunk download queue; and
subsequent to obtaining the particular data chunk download event from the chunk download queue, executing a respective second lambda of a plurality of second lambdas, each respective second lambda configured to construct a respective recap editable page.

3. The method of claim 1, wherein:
each corresponding plurality of aggregated values comprise:
a first aggregated value corresponding to number of pages created by each respective user of the plurality of users within the predetermined period;
a second aggregated value corresponding to a number of comments created by each respective user of the plurality of users within the predetermined period; and
a third aggregated value corresponding to a number of pages viewed by each respective user of the plurality of users within the predetermined period.

4. The method of claim 1, further comprising:
subsequent to constructing the particular recap editable page corresponding to the particular user, generate a notification, the notification comprising:
a summary narrative based on the particular recap page, the summary narrative comprising at least two preview objects generated from at least two editable objects from the corresponding plurality of editable objects; and
a link selectable to cause navigation to the particular editable page.

5. The method of claim 4, wherein the notification is caused to display in a window overlayed over a user interface of an issue tracking platform associated with the particular user.

6. The method of claim 1, further comprising:
for each user of the plurality of users:
identifying a respective plurality of pages associated with interactions between the particular user and the content collaboration platform;
calculating a page interaction value for each page of the plurality of pages based on a number of interactions;
selecting the first page from the plurality of pages based on the respective calculated interaction value; and
generating the selectable graphical element associated with the first page.

7. The method of claim 1, wherein the plurality of users is selected from a global number of users of the at least two platforms satisfying a recap generation criteria.

8. A method for aggregating platform event data on a platform-wide basis for a plurality of users and generating user-specific recap pages within a content collaboration platform, the method comprising:
for each user of the plurality of users:
receiving a plurality of data events generated from the content collaboration platform, the plurality of data events occurring over a predefined period of time, the plurality of data events associated with each user, each data event of the plurality of data events comprising a respective data event type from a plurality of data event types;
for a first data event type of the plurality of data event types, compute a respective first value by aggregating data events from the plurality of data events having the first data event type; and
for a second data event type of the plurality of data event types, compute a respective second value by aggregating data events from the plurality of data events having the second data event type, the first data event type different from the second data event type;
generating an aggregated data table comprising:
a user ID for each user of the plurality of users; and
the respective first and second value for each user of the plurality of users;
partitioning the aggregated data table into a plurality of data chunks, the partitioning based on a file size of the data table and a number of the plurality of users, each data chunk comprising a respective subset of users and including data from a plurality of tenants;
downloading each respective data chunk of the plurality of data chunks via a respective first serverless compute service of a plurality of first serverless compute services;
for a particular data chunk, generating a plurality of editable pages within the content collaboration platform, each editable page of the plurality of editable pages corresponding to a respective user of the subset of users from the plurality of users, each editable page of the plurality of editable pages comprising the respective first value and second value for each user of the subset of users;
in response to generating a particular editable page from the plurality of editable pages, generating a notification to a particular user associated with the particular editable page, the notification comprising:
a summary of the content of the editable page, the content generated based on at least a portion of row data from the aggregated data table corresponding to the particular user; and
a link configured to redirect the particular user to the particular editable page within the content collaboration platform;
subsequent to a user selection of the link and in response to the particular user satisfying an authentication criteria, causing display of the particular editable page within a user interface of the content collaboration platform, the user interface of the content collaboration platform comprising:
a navigation panel including an array of tree elements arranged hierarchically, each tree element of the array of tree elements selectable to cause display of a respective page; and
a content region configured to display the particular editable page including:
a first editable object based on the first value; and
a second editable object based on the second value; and
in response to a user input, publishing the particular editable page, the published particular editable page viewable to other users of the content collaboration platform satisfying a permissions scheme.

9. The method of claim 8, wherein:
the plurality of data chunks comprise at least 1000 data chunks;
the generating the plurality of editable pages within the content collaboration platform for the particular data chunk comprises executing a plurality of second serverless compute services, each second serverless compute services of the plurality of second serverless compute services configured to generate a respective editable page in parallel; and
the method further comprises generating a respective plurality of editable pages for each data chunk of the at least 1000 data chunks.

10. The method of claim 8, further comprising:
computing a respective third value for each page of a plurality of pages associated with the particular user, the computing comprising aggregating a number of data events from the plurality of data events having a third data event type, the third data event type different from the first and second data event types;
selecting a user-edited page from the plurality of pages based on a particular third value corresponding to the user-edited page;
obtaining a particular page ID corresponding to the user-edited page;
retrieving page content associated with the page ID;
generating a selectable graphical element including a portion of the page content, the selectable graphical element operable to cause navigation to the user-edited page; and
causing display of the particular third value displayed adjacent to the selectable graphical element within the particular editable page.

11. The method of claim 8, further comprising:
prior to causing display of the particular editable page, causing display of a preview page comprising:
at least a portion of the particular editable page, including the first value and the second value;
a first user control configured to cause display of the particular editable page in the content region of the content collaboration platform; and
a second user control configured to cause the particular editable page to publish.

12. The method of claim 8, wherein:
the first event type is a page edit data event; and
the second event type is a page view data event.

13. The method of claim 8, wherein the first event type is one of a page creation data event, a whiteboard creation data event, a database creation data event, a blog creation data event, or a selectable graphical element creation data event.

14. The method of claim 8, further comprising:
subsequent to generating the notification, causing display of a window overlayed over the content region, the window comprising the notification, the notification operable to cause navigation to the particular editable page in response to a user selection.

15. A method for generating a respective recap page for each eligible user on a platform-wide basis, each respective recap page configured to narrate a corresponding eligible user’s use of a content collaboration platform during a predetermined period of time, the platform-wide basis including a plurality of tenants, the method comprising:
for each eligible user of a platform-wide user base, the platform-wide user base comprising a plurality of tenants of the content collaboration platform:
computing, from a plurality of data events associated with each eligible user, a respective first aggregated value based on a number of pages created by each eligible user during a predetermined period of time and a respective second aggregated value based on data events associated with a respective user-edited page;
generating a platform-wide recap table comprising:
a user ID corresponding to each eligible user;
the respective first aggregated value computed for each eligible user;
the respective second aggregated value computed for each eligible user; and
a respective page ID associated with each respective user-edited page;
in response to receiving a message from a message queue comprising a data chunk index corresponding to a data chunk from the recap table, downloading the data chunk of the recap table, the data chunk comprising data from a subset of eligible users from the platform-wide user base, the subset of users including users associated with at least two tenants from the plurality of tenants;
from the data in the downloaded data chunk:
generating a plurality of recap pages corresponding to the subset of eligible users within the content collaboration platform, the plurality of recap pages comprising:
a first editable object generated based on the respective first aggregated value;
a second editable object generated based on the respective second aggregated value; and
a respective graphical element associated with each respective user-edited page; and
subsequent to authenticating a particular user in accordance to an authentication criteria, causing display of a particular recap page within a user interface of the content collaboration platform, the user interface of the content collaboration platform comprising:
a navigation panel including an array of tree elements arranged hierarchically, each tree element of the array of tree elements selectable to cause display of a respective page; and
a content region configured to display the particular recap page as an editable page, the particular recap page comprising a graphical user element selectable to cause navigation to a particular user-edited page.

16. The method of claim 15, further comprising:
subsequent to generating the particular recap page and in response to a user input, publishing the particular recap page, the publishing adding view access to a subplurality of users different from the particular user.

17. The method of claim 15, wherein the graphical user element comprises at least a portion of content from the particular user-edited page.

18. The method of claim 15, wherein the plurality of data events is a first plurality of data events and further comprising:
for a second plurality of data events generated from an issue tracking platform, and associated with each eligible user:
computing, a respective third aggregated value based on a number of issue items associated with each eligible user in a predetermined period of time; and
generating the platform-wide recap table further comprising each respective third aggregated value.

19. The method of claim 18, wherein:
each recap page comprises:
a first section including the respective first aggregated value and the respective third aggregated value;
a second section including the respective graphical element associated with the content collaboration platform; and
a third section including the respective third aggregated value associated with the issue tracking platform.

20. The method of claim 19, wherein:
the respective selectable graphical element is a first respective selectable graphical element; and
the third section further includes a respective second graphical element selectable to cause display of an issue item in an issue tracking platform.
